(19) United States
(12) Patent Application Publication
(10) Pub. No.: US 2026/0001809 A1
(43) Pub. Date: Jan. 1, 2026

(54) SUBSTRATE WITH ANTI-FOGGING PROPERTIES

(71) Applicant: FUSION BIONIC GMBH, Dresden (DE)

(72) Inventors: Tim KUNZE, Dresden (DE); Sabri ALAMRI, Dresden (DE)

(21) Appl. No.: 19/108,193

(22) PCT Filed: Sep. 4, 2023
(86) PCT No.: PCT/EP2023/074180

§ 371 Date: Mar. 3, 2025

(30) Foreign Application Priority Data
Sep. 2, 2022 (LU) LU103001

(51) Int. Cl. C03C 23/00; B29C 59/16

(52) U.S. Cl. CPC C03C 23/0025; B29C 59/16

(57) ABSTRACT

The present invention relates to the field of patterning substrates with periodic dot structures in the micro- and/or sub-micrometer range, in particular a patterned substrate and a method for patterning surfaces of a transparent substrate by means of laser interference patterning. The patterning produced in this way with periodic dot structures in the micro- and/or sub-micrometer range is characterized by pronounced anti-fogging properties.

### TECHNICAL FIELD

The present invention relates to the field of patterning of substrates, in particular a patterned substrate-two-dimensional substrates are mentioned here as examples—with anti-fogging properties, which comprises a periodic dot structure, in particular a first periodic dot structure, preferably a hierarchical periodic structure, which has anti-fogging properties. In addition, the present invention relates to a device and a method for patterning surfaces of a transparent substrate by means of laser interference patterning.

### PRIOR ART

Methods for the treatment of surfaces are known from the prior art, with which the surface of transparent substrates, in particular glass, but also solid polymers, can be modified in such a way that the wetting properties of the surface, in particular the hydrophilicity of the surface of a substrate, are improved or increased so that the substrate has anti-fogging properties. By treating the surface, droplet formation on the surface is prevented and instead water runs onto the substrate to form a thin, homogeneous film, which ensures that the substrate remains transparent even under unfavorable environmental conditions. Typical methods apply an additional material to the surface of the substrate for this purpose (so-called structure- or layer-building methods), whereby the additional material has a high hydrophilicity.

A method has been published (“Characterization of Multilayer Anti-Fog Coatings”, Chevallier et al., American Chemical Society 2011), which comprises the following steps: Activation of the surface of a substrate, in particular glass, by plasma treatment to generate amino groups on the surface, application of poly (ethylene maleic anhydride) (PEMA) and application of polyvinyl alcohol (PVA), where PEMA acts as an interface between the functional groups on the surface of the substrate (amino groups) and the hydroxide groups of the PVA. PVA has the necessary hydrophilic properties to ensure that the applied coating has anti-fogging properties.

The disadvantage of such a method, however, is that such a coating is susceptible to mechanical stress (abrasion, impact) and therefore shows a rapid decline in quality due to rapid degradation. After some time, the coating therefore often detaches from the substrate and/or loses its anti-fogging properties.

The method is also based on the use of various chemicals, which have a low environmental compatibility and are often costly to dispose of. In addition, the chemicals used must be adapted to the substrate to be coated, meaning that this solution is not universally applicable for every type of substrate.

From scientific publications (“Microfabrication and Surface Functionalization of Soda Lime Glass through Direct Laser Interference Patterning”, Soldera et al., Nanomaterials 2021), methods for direct laser interference patterning are known, which are used to generate structures on soda lime glass in order to give the material hydrophilic properties. The generated dot-like or linear structures have an interference period of 2.3 μm or 9 μm and can be generated by direct laser interference patterning (DLIP). Linear structures with an interference period of 300 nm are superimposed on the dot-like or linear structures generated by DLIP, which are referred to as laser-induced periodic surface structures (LIPSS). These structures are created by a self-organization process, which is generated by exciting (heating) the glass at points where the interference pattern used for DLIP has a high radiation intensity. Due to the high energy input of the incident laser beam at these points, the heated substrate is reshaped in such a way that a quasi-periodic line pattern is created in which the substrate subsequently solidifies. The term quasi-periodic refers to regularly repeating structural features which, in contrast to a truly periodic structure, have deviations in the interference period, although these deviations are in a range significantly smaller than the dimensions of the structural features, preferably in the range of up to 20%, preferably up to 10% and particularly preferably up to 5% of the dimensions of the structural features. This results in superimposed linear structures in addition to the dot-like or linear structures generated by DLIP. The resulting overall structure is also referred to as a hierarchical structure. Soda-lime glass with such a structure has anti-fogging properties.

However, these methods require a complex conversion and realignment of more than one optical element in the beam path to control the structures generated. In industrial applications with a high throughput of substrates to be patterned with different requirements for the desired structure widths, this requires regular movement and adjustment of the optical elements in the beam path, which makes the process less flexible and exposes the optical elements to greater wear and risk of damage due to regular handling.

In addition, the minimum structure dimensions that can be generated by direct laser interference patterning are limited to the micrometer range. However, this results in disadvantageous diffraction effects on the surface of the substrate, which can lead to a rainbow-like shimmer that impairs the transparency of the surface and the color impression. For applications that require a transparent substrate, this type of patterning, in particular the selection of the interference period, is unsuitable.

Furthermore, a method for generating hierarchical micro-textures using laser-patterned stamps is known (“Hierarchical Microtextures Embossed on PET from Laser-Patterned Stamps”, Bouchard et al., Materials 2021), whereby the laser-patterned stamp is generated using Direct Laser Writing (DLW) and Direct Laser Interference Patterning (DLIP). The stamp, in particular a stainless-steel stamp, is used to transfer the generated hierarchical micro-textures or—structures onto a PET substrate. A hot embossing technique is used for the transfer. In addition to patterning using DLIP, patterning using direct laser writing is also used in this publication. Herein, a laser beam is directed directly onto the material in order to pattern the substrate within the maximum intensity range, in particular to create a cone-shaped structure. Herein, DLW is used to generate pattern widths in the range of 110 μm, which are superimposed with further structures generated by DLIP, whereby these further structures have interference periods of 3.1 μm. The hierarchical structures applied confirmably change the properties of the PET substrate. In particular, the patterned PET substrate displays hydrophobic properties, especially a water contact angle of over 90°, while the unpatterned substrate displays a water contact angle of 76.7° and thus slightly hydrophilic properties.

However, such a PET substrate does not display any pronounced anti-fogging properties, as the patterning does not lead to distinct hydrophilic properties, but only hydrophobic properties. Furthermore, there is no option is demonstrated to pattern a PET substrate using DLIP, as an embossing process is necessary to transfer the structures.

### Objective

It is therefore the objective of the present invention to provide a patterned substrate with anti-fogging properties which can be generated by a simple method.

In addition, it is the objective of the present invention to generate a patterning which is as robust as possible and which does not lose its effectiveness by strain to the substrate, in particular a transparent substrate. Furthermore, it should be possible to pattern flat substrates within a short time.

A further objective of the invention is to provide a method for patterning by means of laser interference which is independent of the intensity of the laser radiation source. The method should be configured so that the optical elements are not damaged even at high intensities on the substrate to be patterned.

A further objective is the functionalization or processing of non-planar, in particular three-dimensional, substrates.

In particular, it is also the objective of the invention to provide a patterning process which can be used for a wide range of substrates, in particular transparent substrates, and which effectively imparts anti-fogging properties to them. In particular, a reproducible water contact angle, which characterizes the hydrophilic properties of the surface, is of importance.

It is particularly important to emphasize that the transparency of the transparent substrate should not be impaired by patterning, i.e. it must be undiminished after patterning without being affected by diffraction effects.

### Solution

The technical objective is fulfilled by a patterned substrate with the features of claim 1 and by a method and use according to the subsidiary claims.

Claim 1 relates to a patterned substrate with a surface with anti-fogging properties, wherein the surface consists of a patterned and an unpatterned region, wherein the patterned region is formed by a first periodic dot structure in the micro- or submicrometer range with a first interference period in the range from 50 nm to 50 μm or comprises a first periodic dot structure in the micro- and/or submicrometer range with a first interference period in the range from 50 nm to 2.0 μm or in the range from 9.5 μm to 50 μm. The first periodic dot structure is formed from inverse cones or cones, and the surface of the substrate comprising the first periodic dot structure has a water contact angle of less than 20°, preferably less than 10°, preferably less than 5° when wetted with water.

Further advantageous embodiments can be found in the description and the dependent claims.

Preferably, the invention relates to a patterned substrate with anti-fogging properties which is patterned by a periodic dot structure in the micro- and/or submicrometer range, wherein the periodic dot structure is formed from inverse cones or cones, characterized in that the periodic dot structure
A) consists of exactly one first periodic dot structure having exactly one first interference period in the range from 50 nm to 50 μm, or
B) consists of at least one first periodic dot structure having at least one first interference period in the range from 50 nm to 2.0 μm and/or dimensions in the range from 9.5 μm to 50 μm,
wherein the surface of the substrate having the first dot structure has a water contact angle of less than 20°, preferably less than 10°, preferably less than 5° when wetted with water.

### General Advantages

The invention advantageously provides a substrate, in particular a transparent substrate with anti-fogging properties, whereby the substrate has a high environmental compatibility, since the use of chemicals during manufacture is dispensed with. Furthermore, compared to conventional chemical coatings, a substrate patterned in this way has a higher wear resistance of the structure generated, as it is insensitive to abrasion and impact.

The patterned substrate, in particular a transparent patterned substrate, has a wide range of applications in the fields of automotive engineering, aviation, photovoltaics, construction, optics, etc., as the anti-fogging properties of the substrate endure independently of the prevailing environmental conditions and stresses.

The invention provides a patterned substrate, in particular a patterned transparent substrate, wherein the structure in one plane of the substrate prevents droplet formation and thus the formation of fogging in this plane by up to 100% and thus ensures that the substrate does not fog up even under corresponding environmental conditions.

In addition, a substrate having a surface consisting of a patterned region according to the invention and an unpatterned region, in particular a patterned region formed by a first periodic dot structure in the micro- or submicrometer range with a first interference period in the range from 50 nm to 50 μm or a patterned region which has a first periodic dot structure in the micro- or submicrometer range with a first interference period in the range from 50 nm to 2.0 μm or from a patterned region which has a first periodic dot structure in the micro- or submicrometer range with a first interference period in the range from 9.5 μm to 50 μm, is characterized in that it has hydrophilic properties. Advantageously, a reliably reproducible water contact angle in particular can be realized by the selected parameters.

In addition, a patterned substrate having a surface with anti-fogging properties, wherein the surface consists of a patterned and an unpatterned region, wherein the patterned region is formed by a first periodic dot structure in the micro- or sub-micrometer range with a first interference period in the range of 50 nm to 50 μm, is characterized in that the surface properties of the substrate can be precisely controlled. According to an advantageous embodiment of the method, it is also possible to control that the optical properties of the substrate, in particular its transparency, are not impaired by the occurrence of quasi-periodic wave structures, so-called LIPSS, which arise from uncontrolled self-organization processes. The depth of the structures, i.e. the structure depth, is advantageously limited by single irradiation with limited intensity. In particular, the precise adjustability of low structure depths ensures that the optical properties of the patterned substrate do not deteriorate compared to those of the unpatterned substrate. Furthermore, the avoidance of self-organization processes means that the properties of the substrate, in particular the water contact angle, can be set in a particularly controlled manner, thus ensuring reliable generation of hydrophilic and super-hydrophilic properties of the surface.

### DETAILED DESCRIPTION

The patterned substrate according to the invention describes a substrate comprising a first periodic dot structure in the micro- and/or sub-micrometer range, in particular with anti-fogging properties on the surface of the substrate. The invention further comprises a method for generating a patterned substrate with anti-fogging properties.

### Substrate

For the purposes of the invention, the term substrate refers to a substrate whose surface has an extension in several spatial directions. A substrate, preferably an extensive and/or transparent substrate, may be a planar substrate or a curved substrate, for example a parabolic substrate. For the purposes of the invention, extensive also means that the extent of a substrate, preferably an extensive and/or transparent substrate, for example a planar substrate in the x and y directions, or the extent of a curved substrate along its radius of curvature is greater than the extent of the region in which the at least three sub-beams interfere with each other.

In a preferred embodiment, the substrate is a substrate whose expansion in the x and y directions or whose expansion along a radius of curvature is less than or equal to the expansion of the region in which the at least three sub-beams interfere with each other. Homogeneous patterning of the substrate is possible in one processing step (during a laser pulse).

In a particularly preferred embodiment, the substrate is an extensive substrate whose extent in the x and y directions or whose extent along a radius of curvature is greater than the extent of the region in which the at least three sub-beams interfere with each other. By moving the substrate in the x and y plane, extensive, homogeneous structuring of the substrate is possible in several processing steps (with several laser pulses). The substrate can be moved by rotation or translation or by a superposition of rotation and translation.

For the purposes of the invention, the term substrate refers to a solid material with a reflective surface or a surface on which condensation forms in the form of fine water droplets under appropriate environmental conditions. Examples of such materials are in particular glasses.

With regard to the substrates which can be processed by applying the laser interference patterning method according to the invention with a dot structure, preferably periodic dot structure, e.g. a first periodic dot structure with anti-fogging properties, there is a wide choice of transparent and translucent but also non-transparent materials within the scope of the present invention. Preferably, the substrate is an extensive and/or transparent material. The substrate can be designed as a flexible and/or bendable substrate, such as an (artificial) leather, a metal foil, a thin sheet or a plastic film, such as is used, for example, in a solar film or in displays.

In a particularly preferred embodiment, the extensive substrate comprises a transparent material, preferably the substrate consists of a transparent material. A material or substrate is transparent in the sense of the present invention if it has a high transmittance for at least a sub-range of the spectrum of electromagnetic radiation between 1 nm and 1 m.

In a particularly preferred embodiment, the extensive substrate comprises a transparent material, preferably the substrate consists of a transparent material. A material or substrate is transparent in the sense of the present invention if it has a high transmittance for at least a sub-range of the spectrum of electromagnetic radiation between 1 nm and 1 m. Such partial ranges are, for example, electromagnetic radiation in the range of visible light from 380 nm to 780 nm or in a range which also includes infrared light, from 380 nm to 5,000 nm or in a range of infrared light or in a range of microwave radiation or also another partial range which is adapted according to the desired application, in particular to the wavelength of the laser source. Such a sub-range preferably has a width of at least 10% or 50% of the wavelength, which forms the lower limit of the sub-range. For the purposes of the invention, a high transmittance in a partial range is a transmittance of at least 50% or preferably at least 70% or particularly preferably at least 80% or at least 90% for each wavelength in the partial range, i.e. for the entire spectrum in the partial range. However, a transparent substrate can also be described as a substrate which selectively has a high transmittance for certain wavelength ranges in the visible light range, e.g. the substrate has a high transmittance for electromagnetic radiation with wavelengths in the range from 500 nm to 800 nm. The transmittance can vary over the wavelength range that is transmitted, e.g. not less than 70% for wavelengths in the range from 380 nm to 500 nm and not less than 90% in the range from 500 nm to 750 nm.

For the purposes of the present invention, a transparent material includes transparent materials, in particular glass (e.g. borosilicate glasses, quartz glasses, alkaline-earth-alkali-silicate glasses (e.g. soda-lime glass), aluminosilicate glasses, metallic glasses), but also solid polymers (e.g. polycarbonates, such as Makrolon® and Apec®; polycarbonate blends, such as Makroblend® and Bayblen®; polymethyl methacrylate, such as Plexiglas®;

polyester; polyethylene terephthalate, polypropylene, polyethylene) as well as transparent ceramics (e.g. spinel ceramics, such as Mg—Al spinel, ALON, aluminum oxide, yttrium aluminum garnet, yttrium oxide or zirconium oxide) or mixtures thereof. Polycarbonates are homopolycarbonates, copolycarbonates and thermoplastic polyester carbonates.

According to a particularly preferred embodiment, the transparent material comprises a glass (as defined herein).

The silicate framework of glass preferably provides a transmission window for wavelengths in the range between 170 nm and 5,000 nm, i.e. wavelength range that includes visible light in the range of 380 nm to 780 nm and includes infrared radiation.

In addition, a glass in unpatterned state exhibits slight hydrophilicity, or hydrophilic properties. In the context of the invention, hydrophilicity means a substrate has water-attracting properties, which are defined in particular by the water contact angle. The water contact angle refers to the angle that forms between the surface and a water droplet wetting it, whereby the angle between the outer surface of the droplet at the outer contact point and the surface is measured. If the water contact angle is greater than 90°, the substrate is said to be hydrophobic. If the water contact angle is less than 90°, it is referred to as a hydrophilic surface. Preferably, a substrate in the context of the invention is a glass with a water contact angle below 90°, particularly preferably below 80°, particularly preferably in the range of below 40° or below 20°.

The water contact angle of a surface is determined using drop contour analysis. This image analysis method uses the shadow image of a drop placed or lying on the surface, whereby its shape on the surface is analyzed. A drop of 2 μl deionized water on the surface of the substrate is used. The ambient temperature is 22° C. Alternatively, the substrate, preferably flat and/or transparent substrate, can also comprise an opaque material. By patterning the non-transparent material, a periodic dot structure in the micro- and/or sub-micrometer range, preferably a first periodic dot structure, is generated on the surface of the non-transparent material. As a result, a structure can be generated on an opaque material which can act as a negative for an anti-fogging structure. In particular, such a structure can be used as a stamp to transfer the structural properties to a desired transparent substrate. Suitable non-transparent materials include metals (e.g. silicon, aluminum, copper, gold), metallic alloys (e.g. steel, brass), enamel-coated metals or glasses and ceramic materials (e.g. zirconium oxide, titanium dioxide, zirconium dioxide) as well as combinations thereof. For example, a substrate patterned in this way is suitable as a negative mold for the indirect application or generation of structures on another substrate.

Polymers such as polyethylene (PE), polyethylene terephthalate (PET), polypropylene (PP), polyamides (PA), polyacrylonitriles (PAN), polyurethanes (PUR), polyvinyl chloride (PVC), polyether ether ketones (PEEK) or polyfluorinated hydrocarbons such as Teflon are also suitable substrates.

### Dot Structure/Interference Pattern/Anti-reflection Glazing

For the purpose of the present invention, the term inverse cones refers to structures with a circular, elliptical, triangular or substantially rectangular base, in particular with a circular base, which converge in a conical shape in the vertical direction into the substrate and have a rounded cone tip at their saddle point. The inverse cones are formed during the patterning process, i.e. when a laser pulse hits the substrate to be patterned as a result of a high-intensity region hitting the substrate, whereby the regions between the inverse cones on or within the substrate ideally remain essentially unpatterned due to destructive interference whose intensity is zero. Consequently, by focusing the laser (sub-) beams on or within the substrate, the negative of what the intensity distribution specifies is formed. The described shape of the inverse cones refers to dot structures that are arranged on the surface of the substrate. An arrangement of the dot structures in or along a plane within the volume results in a shape which is more symmetrical.

Cones with an elliptical base can be generated, for example, by tilting the substrate in relation to the angle of incidence of the focused laser (sub-) beam(s).

The period of the structure is referred to as p for the purposes of the invention. It is generally dependent on the wavelength of the interfering laser (sub-) beams, the angle of incidence of the interfering laser (sub-) beams and the number of interfering laser (sub-) beams.

For the purposes of the invention, a periodic dot structure is generally understood to be a structure which has dot-shaped, regularly repeating structural features. In particular, the regularly repeating structural features are inverse cones. The regularity of the structural features is defined in such a way that the individual structural features are positioned relative to one another in such a way that their spacing across the substrate or between interference pixels is constant.

The inventors have established a connection between the surface properties of a substrate and the formation of condensation, in particular in the form of fog or mist, on its surface. In particular, so-called anti-fogging properties can be generated if the structure size on the surface of a substrate is sufficiently small. Research results have shown that a substrate with hydrophilic and/or superhydrophilic properties can also exhibit anti-fogging properties.

In the context of the invention, anti-fogging properties are understood to mean that no or only very little water, preferably only up to 15%, particularly preferably only up to 10% and even more preferably only up to 5% of the water present, condenses on the surface of a substrate in the form of droplets, this property being attributable to the surface properties, in particular the surface roughness.

A patterned substrate with anti-fogging properties, referred to herein as an anti-fogging glazing, describes in the sense of the invention a substrate, preferably flat and/or transparent substrate, with a periodic dot structure, preferably a first periodic dot structure, with structure widths in the micro- or submicrometer range, i.e. in the range from 50 nm to 50 μm. These anti-fogging properties are achieved when the dimensions of the generated structure, i.e. the interference period and the dimensions of the individual inverse cones, increase the surface roughness of the substrate so that the hydrophilic properties of the unstructured surface are enhanced so that contact angles in the range of 0° to 20°, preferably 0° to 15°, particularly preferably 0° to 10°, most preferably 0° to 5° are formed when wetting with water, thus creating a superhydrophilic surface. The increased surface roughness is based on the fact that the surface texture is changed in the micro- or submicrometer range by the periodic dot structure introduced into the substrate, in particular on the fact that the surface of the substrate has indentations due to the periodic dot structure introduced.

The patterned substrate thus has a layer made of a material whose unpatterned surface has hydrophilic properties, i.e. a water contact angle of less than 90°. This layer must be arranged on the patterned substrate so that the first periodic dot structure is arranged in this layer or at least also in this layer, i.e. this layer is patterned, at least in a partial area. The entire substrate can also be made of this material, i.e. consist of only one layer of this material.

The substrate thus has a layer on the surface whose material is hydrophilic, whereby an unpatterned surface of this material has a water contact angle of less than 90°, preferably less than 80°. As a result, the patterning of a surface of this material efficiently produces a patterned substrate with a patterned surface with superhydrophilic properties, which preferably has a water contact angle of less than 20°, preferably less than 10° and particularly preferably less than 5°.

Furthermore, the inventors have discovered that a substrate patterned thus can also have anti-reflection properties. These anti-reflection properties are achieved if the dimensions of the structure generated, i.e. the interference period and dimensions of the individual cones, are in ranges smaller than the wavelength of visible light, i.e. preferably below 700 nm, preferably below 500 nm.

In physics, reflection is the bouncing back of an electromagnetic wave at an interface of materials with different refractive indices. The angle of reflection and the angle of transmission of light in transparent substrates can generally be calculated using Snellius' law of refraction as follows

$${n}_{1} sin {δ}_{1} = {n}_{2} sin {δ}_{2}$$

where n1 and n2 indicate the refractive index of air and the substrate and δ1 and δ2 indicate the angles of the incident and reflected beam respectively.

Due to the periodic dot structure on the surface or in the volume of the substrate, preferably an extensive and/or transparent substrate, the refractive index of the substrate changes in such a way that a gradual refractive index ensues. As a result, light with wavelengths greater than the structural period p of the periodic dot structure is increasingly transmitted. Light with wavelengths shorter than or equal to the periodic dot structure is diffracted at the surface.

In the context of the invention, anti-reflection properties refer to periodic dot structures whose dimensions lie within the range of the incident electromagnetic wave, so that the incident wave is diffracted away from the observer in such a way that no reflection is perceived as “disturbing”. In addition, the term anti-reflection properties in the sense of the invention also includes that the refractive index at the boundary between the first medium, for example air, and the substrate, preferably extensive and/or transparent substrate, is gradual, so that there is no clear transition from one medium to the other for the incident electromagnetic wave and the incident electromagnetic wave is increasingly transmitted.

The refractive index of the patterned substrate is gradual due to the generated periodic dot structure, preferably a first periodic dot structure. It decreases over the height of the structure so that there is no clear air-medium transition. This results in increased transmission of incident electromagnetic waves with a wavelength greater than the interference period of the generated dot structure, and diffraction of incident electromagnetic waves with a wavelength in the range of the interference period of the generated dot structure.

The present invention also concerns a patterned substrate (5) with a surface with anti-fogging properties, wherein the surface consists of a patterned and unpatterned region, whereby the patterned region is formed by a first periodic dot structure with an interference period in the micro- or sub-micrometer range, wherein the periodic dot structure is formed from inverse cones, and wherein the inverse cones are periodically spaced with a distance relative to their respective saddle point or center of height (circular base) in the range from 50 nm to 50 μm. A substrate patterned thus is characterized in that it has a first periodic dot structure with exactly one interference period. There are no superimposed periodic structures that have a second interference period. This results in more precise control of the substrate properties, in particular the transparency of the substrate, which is not impaired by the patterning due to the low structure depths resulting from the fact that each interference pixel is only irradiated once.

In addition, such a substrate offers good control of the hydrophilic properties of the substrate, as a specific water contact angle can be reliably generated on the substrate surface. Such reliable reproducibility of the water contact angle can be achieved by avoiding potentially occurring LIPSS structures by using single irradiation, i.e. a single laser pulse to generate the periodic dot structure, preferably the first periodic dot structure. Single irradiation prevents the occurrence of uncontrolled self-organization processes, which lead to LIPSS structures, also referred to as quasi-periodic wave structures in the sense of the invention.

LIPSS structures disadvantageously often occur when a dot structure, preferably a first dot structure, preferably a first periodic dot structure, within an interference pixel is irradiated several times in succession, i.e. with several pulses. The resulting self-organization processes are difficult to control, which has a negative impact on reproducibility.

Preferably, the interference period of the first structure, in particular of the first periodic dot structure, which forms the patterned region, is in the range from 200 nm to 50 μm, preferably 200 nm to 20 μm, most preferably from 200 nm to 10 μm, most preferably in the range from 200 nm to 500 nm.

Preferably, the proportion of the patterned region, in particular the surface area of the substrate, is 5% to 100%, preferably 10% to 70%, particularly preferably 20% to 50% of the total surface area of the substrate.

Preferably, the substrate according to the invention has at least one periodic dot structure, preferably a first periodic dot structure, which is formed from inverse cones, wherein the inverse cones have regular, repeatable structure dimensions. In addition to the interference period, i.e. the distance between the inverse cones in relation to their saddle point, the structure dimensions also relate to the structure depth and/or the base area of the inverse cones. The structure depth of the inverse cones, i.e. the distance between the saddle point of the inverse cones and the surface of the unpatterned substrate, is preferably 0.05 μm to 2 μm, particularly preferably 0.1 μm to 1 μm. The low structure depths make it advantageous to maintain the optical properties, in particular the transparency of the unpatterned substrate, as the periodic dot structures introduced do not have a “disturbing” effect due to the low structure depth. The transparency of the patterned substrate differs from that of the unpatterned substrate of the same structure by a maximum of 10%, preferably by a maximum of 5% or 2%, whereby the transparency of the patterned substrate is preferably lower than that of the unpatterned substrate of the same material and structure. In particular, these shallow structure depths can be generated by single irradiation using a laser pulse with a low laser pulse energy. Alternatively, small structure depths can also be generated by means of multiple irradiation with adapted parameters, in particular pulse energies and pulse durations. The base area of the inverse cones is preferably 10% to 40% of the interference period of the dot structure, preferably a first dot structure, preferably a first periodic dot structure.

According to a particularly preferred embodiment of the invention, the substrate patterned according to the invention has at least a first periodic dot structure with an interference period with dimensions in the micro- and/or submicrometer range, wherein the interference period is in the range from 50 nm to 2 μm, preferably in the range from 100 nm to 700 nm, particularly preferably in the range from 100 nm to 500 nm, most preferably in the range from 100 nm to 300 nm, or in the range from 9.5 μm to 50 μm, preferably in the range from 10 μm to 40 μm, particularly preferably in the range from 12 μm to 35 μm, most preferably 15 μm to 30 μm. The inventors have found that this selection of the generated interference periods of the dot structure, preferably a first dot structure, more preferably a first periodic dot structure, prevents effects on the surface of the substrate which impair the transparency of the substrate. In particular, it has been shown that diffraction effects occur on the surface of the substrate for periodic structures with interference periods above 500 nm and up to 5 μm, in particular in the range from 500 nm to 1 μm. These effects are due to the diffraction of incident electromagnetic radiation with wavelengths in the visible light range. They give the surface of the substrate a rainbow-like shimmer of light, which reduces transparency and has a distracting effect. Therefore, to avoid such an effect, the interference period of the periodic dot structure, preferably the first periodic dot structure, is selected in such a way that the aforementioned area is omitted. This advantageously ensures that the transparency of the substrate is maintained after structuring.

The inventors have also found that the reliability of an anti-fogging glazing is related to the repeatability of the water contact angle that can be generated. The water contact angle, as defined herein, is a measure of the hydrophilicity of the patterned substrate. The smaller the water contact angle, the more hydrophilic the substrate. In this regard, prior art studies are known which came to the conclusion that applying periodic dot structures, preferably first periodic dot structures, with interference periods in the range of 2.5 μm to 9 μm, increases the hydrophilic properties of a substrate, in particular by reducing the water contact angle. The investigations suggest that the water contact angle is more reproducible for smaller interference periods. Reproducible in the sense of the invention means that the same value for the water contact angle can be achieved for different substrates with a different or the same surface roughness before patterning. However, the inventors have found that the water contact angle is particularly reliably reproducible both for interference periods below 2 μm, in particular 50 nm to 2 μm, and for large interference periods above 9.5 μm, in particular 10 μm to 50 μm. Advantageously, the interference period of the first periodic dot structure is therefore selected in the range from 50 nm to 2 μm, or 9.5 μm to 50 μm, so that a higher reproducibility of the water contact angle can be achieved.

According to a preferred embodiment of the invention, the interference period of the first periodic dot structure is in the range of 9.5 μm to 50 μm, preferably 10 μm to 30 μm, particularly preferably 12 μm to 30 μm. Advantageously, reproducible periodic dot structures with reproducible water contact angles can thus be produced particularly reliably, especially on rough and/or curved substrate surfaces.

According to a further embodiment of the invention, the interference period of the first periodic dot structure is in the range from 50 nm to 2 μm, preferably from 100 nm to 1 μm, more preferably in the range from 100 nm to 700 nm, most preferably in the range from 100 nm to 500 nm. The inventors have discovered that antibacterial properties can be detected on the surface of a substrate at interference periods below 2 μm. Advantageously, a substrate structured in this way also has antibacterial, i.e. antiseptic, properties in addition to pronounced anti-fogging properties.

The objective is also fulfilled by a patterned substrate with anti-fogging properties, which has a dot structure, preferably a periodic dot structure, wherein the dot structure consists of superimposed structures, also hierarchical structures, comprising at least a first structure with an interference period in the micro- and/or submicrometer range and a second structure with an interference period in the micro- and/or submicrometer range, wherein the first structure has interference periods and wherein the interference periods can be significantly larger than those of the second structure, in particular the line structure or dot structure, and wherein at least one structure is formed from inverse cones (as defined herein), which can be generated in particular by interfering laser beams. Preferably, the second structure has interference periods with dimensions in the range from 1% to 30%, in particular from 5% to 20%, preferably from 5% to 15% of the dimensions of the interference period of the first dot structure, preferably of the first periodic dot structure.

Advantageously, the anti-fogging properties of a substrate can be additionally enhanced by such hierarchical structures, since a higher degree of hydrophilicity can be achieved. This is due to the fact that hierarchical structures significantly increase surface roughness compared to conventional structures in the micro- or sub-micrometer range.

Preferably, the interference period of the first structure, in particular the first periodic dot structure, is in the range from 50 nm to 2 μm, preferably in the range from 100 nm to 1 μm, particularly preferably in the range from 100 nm to 700 nm, most preferably in the range from 200 nm to 500 nm. Thus, the diffraction effects in the visible range can be advantageously reduced so that a rainbow-like shimmer of the surface is prevented.

According to a further embodiment, the interference period of the first structure, in particular the first periodic dot structure, is in the range from 9.5 μm to 50 μm, particularly preferably in the range from 10 μm to 40 μm or 12 μm to 40 μm, most preferably in the range from 15 μm to 30 μm.

For example, the periodic dot structure, in particular the dot structure of overlapping structures, can be optimally adapted to the requirements of the respective application when using interfering laser beams by choosing the parameters accordingly (selection of the laser beam source, arrangement of the optical elements, pulse duration and intensity, number of laser pulses that hit an interference pixel).

For example, a structure with anti-fogging properties produced in this way is a dot structure, preferably a periodic dot structure, consisting of inverse cones with average dimensions in the micrometer range, in particular with an average distance in relation to their respective saddle point or height center of 9.5 μm to 50 μm. A further structure is superimposed on the first periodic dot structure, the mean dimension of the superimposed structure preferably having dimensions in the range from 50 nm to 2°μm. For the purposes of the invention, such a structure is also referred to as a hierarchical structure.

According to a further embodiment, the superimposed structure has a quasi-periodic line structure, the line structure being in the form of a wave structure, the material on the surface of the substrate in the region of the superimposed structure having a sequence of wave crests and wave troughs whose interference period is in the submicrometer range, preferably in the range from 100 nm to 700 nm, particularly preferably in the range from 100 nm to 500 nm, very particularly preferably in the range from 100 nm to 300 nm. In the sense of the invention, the term quasi-periodic refers to regularly repeating structural features which, however, in contrast to a truly periodic structure, exhibit deviations in the interference period, although these deviations are in a range significantly smaller than the dimensions of the structural features, preferably in the range of 1% to 5% of the dimensions of the structural features. Defects in the structure uniformity, i.e. a missing wave crest or a missing wave trough, are also possible.

The wave structure is formed during the patterning process, i.e. during the impingement of laser pulses, in particular as a result of multiple irradiation, into the substrate to be patterned as a result of the occurrence of a region of high intensity, the patterning taking place by a self-organization process which is stimulated by the at least partial melting of the substrate material by means of laser pulses in a region of high intensity. In particular, the wave structure is generated by utilizing laser-induced periodic surface structures (LIPSS), whereby the occurrence of these surface structures is coupled to the generation of the dot structures, preferably the first periodic dot structures, by means of interfering laser beams. This means in particular that the quasi-periodic wave structures only occur in the areas of the intensity maxima within an interference pixel, in particular within the inverse cones of the first periodic dot structure. The proportion of unpatterned regions occurring in the intensity minima remains the same in relation to patterning by means of a simple periodic dot structure, preferably the first periodic dot structure.

According to a further embodiment, the hierarchical structures are generated by single irradiation of the same interference pixel using laser (partial) beams with high intensity. Advantageously, a two-dimensional patterning of a substrate, for example with anti-fogging properties, is thus possible by means of interfering laser beams and by utilizing laser-induced periodic surface structures, without having to accept a long processing time or a high number of successively executable process steps. The invention thus enables the simultaneous generation of hierarchical structures which can be used in the technical field both in the area of substrates with anti-fogging properties and in the area of self-cleaning, hydrophobic or superhydrophobic or hydrophilic or superhydrophilic substrates, optionally also with anti-icing and/or anti-reflection properties.

Disadvantageously, a predetermined water contact angle can be reproduced less well due to the self-organization processes and the associated uncertainties. In order to nevertheless ensure a reliable process in which a high reproducibility of the water contact angle is achieved, the inventors have determined that certain interference periods are suitable for achieving a reliable and reproducible setting of a desired water contact angle, preferably as small as possible. The patterned substrate is characterized in that the interference period of the first periodic dot structure is in the range from 50 nm to 2.0 μm and/or in the range from 9.5 μm to 50 μm.

According to a further embodiment, the hierarchical structures are generated by multiple irradiation of the substrate with deviating process parameters, whereby the process parameters deviate in particular in such a way that a second periodic structure with a deviating interference period is generated. The second periodic structure is a line structure or a dot structure, preferably a dot structure. In the context of the invention, a line structure refers to a so-called 1D structure consisting of parallel structure peaks and structure valleys, which are arranged in a regular sequence of one peak and one valley each. In this embodiment, the second periodic structure is generated analogously to the first periodic dot structure by direct laser interference structuring. The interference period of the second periodic structure can be set using the process parameters. The generation of the second periodic structure is not coupled to the generation of the first periodic structure. Therefore, a substrate patterned thus has a lower proportion of unpatterned surface compared to a substrate patterned only with a first periodic dot structure, since the unpatterned region remaining after the first periodic dot structure has been generated is partially patterned when the second periodic structure is generated with lower interference periods.

In a preferred embodiment, the first periodic dot structure of the patterned region according to the invention, in particular of a patterned region formed by a first periodic dot structure in the micro- or submicrometer range with a first interference period in the range from 50 nm to 50 μm, or of a patterned region which has a first periodic dot structure in the micro- or submicrometer range with a first interference period in the range from 50 nm to 2.0 μm, or a patterned region which has a first periodic dot structure in the micro- or submicrometer range with a first interference period in the range from 9.5 μm to 50 μm, has dimensions which are significantly larger, at least 10% to 30% larger, than the bacteria deposited on it. As a result, the bacteria deposited on the surface are isolated and thus rendered harmless. Cell division of the bacteria within the dot structures and the associated outgrowth of the bacteria from the dot structures is prevented due to the dimensions. In a particularly preferred embodiment, the periodic dot structure, preferably the first periodic dot structure, has dimensions that are significantly smaller, at least 10% to 30% smaller, than the bacteria deposited on it. This prevents the bacteria from adhering to the surface and the surface is kept sterile.

According to a further embodiment of the invention, the patterned substrate according to the invention has a surface with a patterned region according to the invention, which is formed by a first periodic dot structure in the micro- or submicrometer range with a first interference period in the range from 50 nm to 50 μm, or from a patterned region which has a first periodic dot structure in the micro- or submicrometer range with a first interference period in the range from 50 nm to 2.0 μm, which has a first periodic dot structure in the micro- or submicrometer range with a first interference period in the range from 50 nm to 2.0 μm, or from a patterned region which has a first periodic dot structure in the micro- or submicrometer range with a first interference period in the range from 9.5 μm to 50 μm, a periodic dot structure, preferably a first periodic dot structure, which is formed from cones. The structural properties, such as the interference period and the hydrophilic properties, in particular the water contact angle, which forms on the surface of the substrate upon wetting, are identical to the properties defined herein of a patterned substrate which has a periodic dot structure, preferably a first periodic dot structure, wherein the dot structure, preferably the first periodic dot structure, is formed from inverse cones. The periodic dot structure produced in this way, preferably a first periodic dot structure, having regularly spaced pegs, is therefore just as suitable for generating a substrate with anti-fogging properties as the periodic dot structure defined herein, preferably a first periodic dot structure, having inverse cones. The structural properties are unchanged.

In one embodiment of the invention, the method and apparatus disclosed herein is suitable for generating a substrate comprising a periodic dot structure in the micro- and/or sub-micrometer range, preferably a first periodic dot structure generated by laser interference patterning, which has an increased surface roughness. The increased surface roughness is based on the fact that the surface texture is changed by the periodic dot structure introduced into the substrate in the micro- and/or submicrometer range, preferably a first periodic dot structure, in particular on the fact that the surface of the substrate has elevations or depressions due to the periodic dot structure introduced, preferably a first periodic dot structure. In particular, an increased surface roughness can be achieved by patterning a substrate by means of the method and device described herein without hierarchical structures by means of single irradiation, the patterned region preferably being formed from exactly one first dot structure, or with hierarchical structures with dimensions in the micrometer and/or submicrometer range by means of laser interference patterning by means of multiple irradiation of the same interference pixel and/or application of a further periodic structure by means of direct laser interference patterning.

### Interference Region or Interference Pixel

The substrate according to the invention comprises a first periodic dot structure in the micro- or sub-micrometer range, wherein the periodic dot structure can be generated by laser beams interfering in an interference region. The interference region is characterized by alternating radiation intensity maxima and minima occurring within its spatial extent. These maxima and minima occur with a periodic, i.e. repetitive regularity and thus form an interference pattern that can be transferred to the substrate. The interference region within which this pattern is recognizable is also referred to as the interference pixel. The extent of the interference pixel is typically circular, but other geometric extents, e.g. elliptical or linear extents, are also conceivable. The interference region within which the interference pattern is recognizable is physically defined by the intensity threshold of the substrate to be processed. The intensity threshold describes the energy at which the material of the substrate interacts with the incident laser beams, so that a change takes place within the material, e.g. melting or removal of the material. In the case of a laser radiation source with a Gaussian radiation profile, the energy of the interfering laser beams occurring at the maxima of the interference pattern decreases towards the edge of the interference region, so that the interference pixel applied to the substrate is smaller than the interference region, whereby the exact size is determined by the properties of the laser radiation source and the substrate.

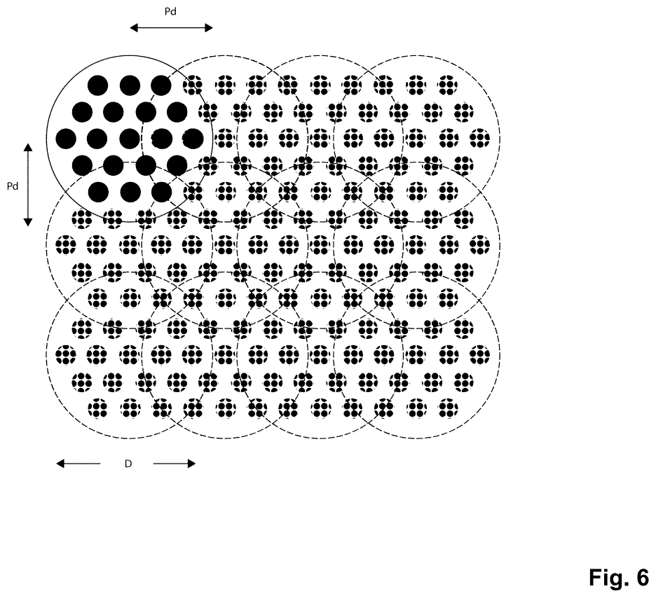

The term interference pixel, e.g. first, second, third and/or further interference pixel, thus refers in the sense of the present invention to a periodic pattern or grid of at least three inverse cones, preferably at least seven inverse cones, most preferably at least 19 inverse cones on the surface of a substrate, which are formed within an interference pixel (cf. FIG. 6). Preferably, the periodic pattern or grating is generated by superimposing at least three, particularly preferably at least four laser (sub-) beams as a result of focusing (bundling) these laser (sub-) beams onto the surface or into the interior of the substrate, whereby the sub-beams interfere constructively and destructively on the surface or in the interior of the substrate.

Preferably, the periodic dot structures within one type of interference pixel have a coefficient of variation (a value resulting from dividing the standard deviation by the average value) of the cross-section of the cone of 15% or less, more preferably 10% or less, even more preferably 5% or less. This also allows better detectability of the substrate patterned according to the invention compared to conventional methods for patterning/coating substrates (e.g, etching, particle blasting, polymer coating), in which the deviations are larger due to the process and the interference period to be generated is less accurately mapped.

The first periodic dot structure and/or a second periodic dot structure is preferably formed so that the patterned substrate transmits electromagnetic radiation with a wavelength of more than 550 nm at a first periodic dot structure of less than 1,000 nm, preferably more than 500 nm at a first periodic dot structure of less than 750 nm, most preferably more than 450 nm at a first periodic dot structure of less than 600 nm. Depending on the structure depth of the inverse cones, wavelengths in the red and/or yellow light spectrum, the green light spectrum and even the blue light spectrum can be transmitted into the substrate.

The refractive index of the patterned substrate is gradual due to the generated periodic dot structure, preferably the first periodic dot structure. It decreases over the height of the structure so that there is no clear air-medium transition. This results in increased transmission of incident electromagnetic waves with a wavelength greater than the interference period of the generated dot structure, and diffraction of incident electromagnetic waves with a wavelength in the range of the interference period of the generated dot structure.

To generate a substrate with hydrophilic properties, it is also conceivable that only a structure with dimensions in the micro- or sub-micrometer range is generated without moving the beam splitter element in an intermediate step.

Advantageously, substrates with hydrophilic and/or superhydrophilic properties can thus be generated by means of the same process and on the basis of the same device in a technically easily realizable manner by generating a periodic dot structure, preferably a first periodic dot structure, in the micro- or submicrometer range and/or a dot structure, preferably periodic dot structure, with a hierarchical structure in the micro- and submicrometer range. By moving the beam splitter element, it is possible to realize at least two, but also any number of additional structures on the surface of the substrate without further changes to the structure, e.g. without replacing optical elements or moving the substrate. This increases both the precision in the alignment of the structures and the speed of the process compared to conventional methods or devices.

The inventors have established a correlation between the surface properties of a substrate and the formation of condensation, in particular in the form of fogging or mist, on its surface.

In particular, so-called anti-fogging properties can be generated if the structure size on the surface of a substrate is sufficiently small. Research results have shown that a substrate with superhydrophilic properties can also exhibit anti-fogging properties.

Such a substrate can be used advantageously in the aerospace sector, in the field of automotive components or also in telecommunications and antenna technology to protect exposed components from fogging.

In one embodiment of the invention, the method and apparatus disclosed herein is suitable for generating a substrate which has a dot structure, preferably a periodic dot structure, in particular a first and/or second periodic dot structure, in the micro- or submicrometer range, which has been produced by means of laser interference patterning, and which is additionally characterized by anti-reflection properties. In the sense of the invention, anti-reflection properties herein refer to the increased transmission or diffraction of incident electromagnetic radiation with wavelengths in the range of visible light, in particular with wavelengths in the range from 400 nm to 700 nm. The substrate is characterized by the fact that the first and/or second periodic dot structure it comprises preferably has dimensions in the submicrometer range, particularly preferably in the nanometer range. Particularly preferred are the dimensions of the periodic dot structure, preferably the first periodic dot structure, in the range of the wavelength of electromagnetic radiation in the range of visible light. Thus, the dimensions of the periodic dot structure, preferably the first periodic dot structure, are preferably in the range from 630 nm to 700 nm for transmitting and diffracting red light, in the range from 590 nm to 630 nm for transmitting and diffracting red and orange light, in the range from 560 nm to 590 nm for transmitting and diffracting red, orange and yellow light, in the range from 500 nm to 560 nm for transmitting and diffracting red, orange and yellow light, and in the range from 500 nm to 560 nm for transmitting and diffracting red, orange and yellow light. Diffraction of red and orange light, in the range from 560 nm to 590 nm for transmission, or diffraction of red, orange and yellow light, in the range from 500 nm to 560 nm for transmission, or diffraction of red, orange, yellow and green light, in the range from 475 nm to 500 nm for transmission, or diffraction of red, orange, yellow, green and turquoise light, in the range from 450 nm to 475 nm for transmitting, or diffraction of red, orange, yellow, green, turquoise and blue light, in the range from 425 nm to 450 nm for transmitting, or diffraction of red, orange, yellow, green, turquoise, blue and indigo-colored light, in the range from 400 nm to 425 nm for transmitting, or diffraction of red, orange, yellow, green, turquoise, blue, indigo-colored and violet light. Thus, by changing the dimensions of the periodic dot structure, preferably the first periodic dot structure, the anti-reflection properties of the substrate can be controlled.

In one embodiment of the invention, the method and apparatus disclosed herein is suitable for generating a substrate comprising a periodic dot structure, preferably a first dot structure, in the micro- or sub-micrometer range, which has been generated by laser interference patterning, and which is additionally characterized by anti-reflection properties. In the sense of the invention, anti-reflection properties herein refer to the increased transmission or diffraction of incident electromagnetic radiation with wavelengths in the range of non-visible light, in particular in the range of infrared radiation, or thermal radiation, in particular with wavelengths in the range of 780 nm to 1 mm. The substrate is characterized in that the periodic dot structure it comprises, preferably the first periodic dot structure, preferably has dimensions in the micrometer range. Advantageously, the heat transmission of the substrate can thus be adjusted by changing the dimensions of the periodic dot structure, preferably the first periodic dot structure.

In one embodiment of the invention, the method and apparatus disclosed herein is suitable for generating a substrate comprising a periodic dot structure, preferably a first periodic dot structure, in the micro- or sub-micrometer range, which has been generated by laser interference patterning, and which is characterized by anti-reflection properties. In the sense of the invention, anti-reflection properties herein refer to the increased transmission or diffraction of incident electromagnetic radiation with wavelengths in the range of non-visible light, in particular in the range of ultraviolet radiation (UV radiation), in particular with wavelengths in the range of 100 nm to 380 nm. The substrate is characterized in that the periodic dot structure, preferably the first periodic dot structure, preferably has dimensions in the nanometer range. A substrate structured in this way can be used advantageously in areas where protection against UV radiation is required.

In a further embodiment of the invention, the method and apparatus disclosed herein is suitable for generating a substrate comprising hierarchical structures which have been generated by laser interference patterning by a multiple irradiation of the same interference pixel and which are characterized by hydrophilic or superhydrophilic properties. The hydrophilic or superhydrophilic properties are caused by structures with dimensions in the micro- or submicrometer range, in particular hierarchical structures with dimensions in the micro- and submicrometer range, which change the water contact angle, also known as the wetting angle, of liquids on substrates so that it becomes smaller. A smaller water contact angle means that liquids hitting the surface wet it very well and there is no droplet formation. Instead, a uniform wetting of the surface is achieved, which does not impair the transparency of the substrate. Materials that already have hydrophilic properties, e.g. glass surfaces, are particularly suitable for such a patterned substrate. A substrate is therefore particularly suitable which has a material that is hydrophilic, whereby an unpatterned surface of the material has a water contact angle of less than 90°, preferably less than 80°. This efficiently generates a patterned substrate with a patterned surface with superhydrophilic properties, which preferably has a water contact angle of less than 20°. In one embodiment of the invention, the method and apparatus disclosed herein is suitable for generating a substrate comprising a periodic dot structure in the micro- or sub-micrometer range, preferably a first periodic dot structure produced by laser interference patterning, which has an increased surface area compared to an unpatterned substrate with the same outer dimensions. The periodic dot structure in the micro- or submicrometer range, preferably a first periodic dot structure, contributes to increasing the surface area of the substrate in proportion to the density of the interference areas per interference pixel.

In particular, an increased surface area compared to an unpatterned substrate with the same external dimensions can be achieved by patterning a substrate by means of the method and device described herein with hierarchical structures with dimensions in the micro- and submicrometer range by means of laser interference patterning by a single irradiation or a multiple irradiation, preferably multiple irradiation, of the same interference pixel. A substrate thus processed can be used advantageously in technical fields with a requirement for high heat transfer, as the increased surface area provides a greater capacity for heat exchange compared to an unpatterned substrate with the same external dimensions. Furthermore, a substrate thus processed can be used in the field of electrical bonding technology to reduce contact resistance, as the increased surface area offers more contact points between materials to be contacted compared to an unpatterned substrate with the same external dimensions. In addition, a substrate patterned in this way can be used in the field of battery technology, in particular for patterning the anode and cathode, as the increased surface area allows for more capacity for exchanging charge carriers between the metal of the electrodes compared to an unpatterned substrate with the same external dimensions.

A patterned substrate produced by the method and apparatus disclosed herein is further suitable for further processing by means of a coating process, wherein the substrate may receive a physical and/or chemical coating. Such a coating can enhance the properties of the patterned substrate, for example the anti-reflection properties and/or hydrophilic and/or hydrophobic properties. The application of a chemical spray coating and/or the application of a coating by means of chemical vapor deposition and/or sputtering is conceivable.

The invention thus also comprises a patterned substrate with a coating. A coating, preferably a protective coating, preferably a transparent protective coating, is arranged on the patterned surface of the patterned substrate. Such a coating, preferably a protective coating, preferably a transparent protective coating, is preferably very thin and has a thickness of 1 nm to 5 μm, for example. As a result, the structure of the patterned surface is essentially retained. Preferably, the coating, preferably protective coating, has a high hardness, which increases and thus improves the durability of the patterned surface of the patterned substrate. It is relevant here that the underlying substrate already has a textured surface, i.e. not only the coating is textured. The combination of a patterned substrate and a thin coating applied to it can generate special properties of the surface, in particular special wetting properties of the resulting patterned surface, through the surface modification in combination with the properties of the materials.

The coating is arranged on the substrate on the patterned surface so that the first dot structure is formed in the coating and is also formed in the underlying layer adjacent to the coating.

The water contact angle of the surface can be defined by the choice of coating material. The surface tension is modified by functional end groups within the coating, resulting in either hydrophilic or hydrophobic properties.

According to an advantageous embodiment, the material for the coating has hydrophobic wetting properties. As a result, a super-hydrophobic property can also be achieved on an underlying hydrophilic material, such as glass.

According to a further advantageous embodiment, the material for the coating has hydrophilic wetting properties. As a result, a particularly durable and stable superhydrophilic surface can be achieved.

Suitable materials for a hydrophobic coating are (nano) coatings based on silicon dioxide, fluorinated silanes and fluoropolymer coatings, manganese oxide-polystyrene (MnO2/PS) nanocomposites, zinc oxide-polystyrene (ZnO/PS) nanocomposites, coatings based on calcium carbonate and also carbon nanotube structure coatings, i.e. a coating which has carbon nanotubes, preferably transparent carbon nanotube structure coatings.

Suitable materials for a hydrophilic coating are, for example, ceramic materials such as BeO-based, MgO-based, TiO2-based, AI203-based, ZrO2-based, ZnO-based, SnO-based, SiO2-based, aluminosilicate-based coatings, silicate-based coatings, spinel ceramics such as Mg—Al spinel, aluminum oxynitride (ALON), yttrium aluminum garnet, yttrium oxide-based coatings, mixed oxide ceramics such as ATZ/ZTA, silicon carbide (SIC), tungsten carbide (WC), aluminosilicates, (layered) silicate matierials and combinations thereof, hydrogels/sol-gel coatings, acrylate-based polymers/acrylamide copolymers, polyurethane-based coatings or polyalcohol epoxide.

Coatings such as hydrogels, acrylate-based polymers and silicon dioxide-based coatings as well as carbon nanotubes are advantageously transparent at low thicknesses, in particular up to 5 μm, and therefore exhibit high transmission. This makes it possible to produce patterned substrates with a coating that exhibit high transmission (as described herein).

Advantageous modifications of the surface include the provision of hydrophobic polymers, such as alkyl chains and/or alkylsilane and/or fluorinated alkyl chains, preferably in the form of polymer brushes. Polymer brushes in the sense of the present invention are dense layers of polymer chains bonded or grafted to a surface, often at one end of the chains. The methods by which surfaces are modified to provide chemical attachment points for the chains are known to those skilled in the art and include, for example, bioconjugation, free radical/anionic/catonic chain polymerization, particularly preferably living chain polymerization and/or surface induced polymerization (SIP). This allows the surface properties such as wettability and adhesion to be subsequently improved after patterning and processing. Preferably, these layers have a layer thickness of 10 to 250 nm, particularly preferably of 20 to 150 nm. These layers are preferably transparent and facilitate influencing physical properties such as hydrophobicity, while the optical properties are not or hardly influenced.

In a particularly preferred embodiment, the coatings are advantageously designed so that a change in conditions, such as temperature or pH value, influences the surface properties. Thus, the hydrophobicity of the material can be controlled, e.g. by increasing the temperature. This is advantageous for controlling wettability and adhesion.

Layer thicknesses can be determined using atomic force microscopy (AFM) and/or ellipsometry in the UV/Vis range.

### Method

The present invention also includes a method for producing a substrate, preferably extensive and/or transparent substrate with anti-fogging properties, comprising a periodic dot structure with dimensions in the micro- or sub-micrometer range, preferably a first periodic dot structure, by means of direct laser interference patterning.

In the context of the invention, the method for producing a patterned substrate with anti-fogging properties, preferably extensive and/or transparent substrate, with a periodic dot structure in the micro- or submicrometer range by means of laser interference patterning, comprises the following steps:

A substrate (5), preferably extensive and/or transparent substrate, is provided, which is located on a holding device. A laser beam is emitted from a laser radiation source (1). The laser beam is divided by a beam splitter element (2) and at least three, preferably four, sub-beams. The sub-beams hit a focusing element (4), which focuses (bundles) the at least three, particularly preferably four sub-beams on the surface or inside the substrate (5), preferably extensive and/or transparent substrate, so that the sub-beams interfere constructively and destructively on the surface or inside the substrate. Thus, a periodic dot structure in the micro- or sub-micrometer range is generated on the surface or inside the substrate (5), preferably extensive and/or transparent substrate, by laser interference processing. The method is characterized in that the at least three sub-beams are superimposed in such a way that a 2D pattern is created.

According to a variant of the method, the periodic dot structure, preferably the first dot structure, is generated within an interference pixel by means of a single laser pulse, referred to herein as single irradiation. Single irradiation means that the interference pixel is only exposed once within a processing step using a single laser pulse. A dot structure with an interference period is therefore created within an interference pixel by exposing it with just one laser pulse. Interference pixels arranged next to each other preferably do not overlap, so that a resulting inverse cone is not illuminated again. A high process speed can therefore be achieved. In addition, the use of single irradiation prevents the occurrence of quasi-periodic wave structures, so-called LIPSS, due to uncontrolled self-organization processes, which change the optical properties of the substrate surface in such a way that the transparency and reproducibility of the water contact angle are impaired. Consequently, the occurrence of LIPSS structures can be prevented by single irradiation. As a result, significantly more precise process control can be achieved and a specific water contact angle can be reliably generated.

Preferably, individual, separate pulses are generated, which can advantageously avoid LIPSS structures.

According to an advantageous variant of the method, longer pulse durations are used, preferably greater than 1 ns, preferably greater than 10 ns. This favors the avoidance of LIPSS structures.

Preferably, small structure depths, in particular in the range from 0.05 to 2 μm, preferably from 0.1 to 1 μm, are achieved by single irradiation. The use of a single laser pulse and the lack of pulse overlap between neighboring interference pixels ensures that the structure depths of the periodic dot structure, preferably the first periodic dot structure, are small. Advantageously, this ensures that the optical properties of the substrate, in particular its transparency, are not impaired compared to the unpatterned substrate. In particular, the transparency of the patterned substrate differs from that of the unpatterned substrate of the same structure by a maximum of 10%, preferably by a maximum of 5% or 2%, with the transparency of the patterned substrate preferably being lower than that of the unpatterned substrate of the same material and structure.

A surface with anti-fogging properties, which is formed from a patterned region and an unpatterned region, can be generated according to a further embodiment of the method in that the same interference pixel is processed by means of several successive laser pulses through multiple irradiation. Multiple irradiation means that the same area of the substrate is processed by several successive laser pulses. A dot structure, preferably a first periodic dot structure, is therefore exposed several times with an interference period within an interference pixel, whereby a resulting inverse cone is exposed again once or several times. The pulse length can be set by the user. Therein an interference pixel is exposed several times before a process parameter, such as the exposure position, is changed.

In particular, in this method the same interference pixel is processed by means of multiple irradiation. Thus, as a result of the successive multiple irradiation with identical process parameters of an interference pixel, a quasi-periodic line structure superimposed on the periodic dot structure, preferably the first periodic dot structure, is formed as a wave structure by self-organization processes. In the context of the invention, process parameters refer to the setting of the distance between the beam splitter element and the focusing element, the laser pulse duration, the laser pulse energy, the laser wavelength and/or the position of the interference area on the substrate. Self-organization processes refer in particular to so-called LIPSS, as known from the prior art. LIPSS occur as a result of partial heating of the substrate surface and subsequent solidification of the same in the form of regular, quasi-periodic (as defined herein) wave structures.

Hierarchical structures on the surface of the substrate can thus be generated quickly and effectively. It is not necessary to readjust the laser interference device and/or realign the substrate. In addition, the structure parameters of the periodic dot structure, in particular the structure depth, can also be adjusted. Preferably, a shallow structure depth is achieved by adjusting the process parameters, in particular the laser pulse energy, in such a way that the energy input from the multiple irradiation per interference pixel remains as low as possible.

Disadvantageously, a predetermined water contact angle can be reproduced less well due to the self-organization processes and the associated uncertainties. In order to nevertheless ensure a reliable process, the inventors have determined that certain interference periods should be observed in order to achieve a reliable and reproducible setting of a desired, preferably as small as possible, water contact angle. The method using multiple irradiation is thus characterized in that the interference period of the periodic dot structure is in the range from 50 nm to 2.0 μm and/or in the range from 9.5 μm to 50 μm. In particular, achieving the desired interference periods of the LIPSS generated by the self-organization processes depends on the material properties of the substrate to be patterned and the properties of the laser beam used for patterning, in particular on the wavelength of the laser beam. A desired interference period can therefore be set via a suitable selection of the laser radiation source.

According to a further embodiment of the invention, a further periodic dot structure or periodic line structure with an interference period different from the interference period of the first periodic dot structure is applied to the substrate by multiple irradiation with different process parameters. The deviating process parameters relate in particular to the distance between the beam splitter element and the focusing element, as a result of which the interference period of the additional periodic dot structure or line structure is changed in comparison to the first periodic dot structure. However, an additional change in the laser pulse duration and/or energy is also possible.

In this way, a flexible second structure with dimensions in the micrometer and/or submicrometer range can be advantageously applied to the substrate, which is independent of the first periodic dot structure. This ensures simple alignment of the interference pixels on the substrate. In addition, the proportion of the patterned region on the substrate surface is increased so that pronounced anti-fogging properties can be achieved. Here too, interference periods in the range from 50 nm to 2.0 μm and/or in the range from 9.5 μm to 50 μm have proven to be reliable. The advantage of such a method is that the interference periods can be precisely controlled by adjusting the beam splitter element and that the desired interference periods can be set independently of the material properties and the properties of the laser beam used for patterning.

Preferably, the distance of the optical beam splitter element from the focusing lens according to the method of the invention is preferably 10 mm to 50 mm or 150 mm to 200 mm. The laser pulse duration is preferably 50 fs to 1 ns, particularly preferably 50 fs to 10 ps. This short laser pulse duration can prevent or at least minimize undesired and/or uncontrolled melting of the substrate (e.g. in the form of a structural or chemical transformation), in particular as a result of local overheating, e.g. due to excessive energy input. This is particularly advantageous in the case of the “sensitive” materials used herein, which the substrates have or of which the substrates consist.

The laser wavelength is preferably 200 nm to 10 μm, preferably 266 nm to 1064 nm.

The laser pulse energy is preferably 50 μJ to 20 mJ, preferably 300 μJ to 800 μJ, particularly preferably 500 to 800 μJ. This low laser pulse energy per laser pulse can prevent or at least minimize undesired and/or uncontrolled melting of the substrate (e.g. in the form of a structural or chemical transformation), in particular as a result of local overheating, e.g. due to excessive energy input. This is particularly advantageous for the “sensitive” materials used in the substrates or of which the substrates are made.

According to a further embodiment of the method, the method additionally comprises the following steps:
providing a further, i.e. second, substrate, the second substrate preferably being transparent, and
embossing the first substrate onto the further substrate, so that a periodic dot structure is formed on the second substrate, which is formed from cones. The first substrate is used as a negative mold for the second substrate. Advantageously, the first substrate can thus be used for embossing any number of further substrates, which can significantly accelerate the process of creating a structured substrate with anti-fogging properties.

### Dot Structure

When generating a patterned and an unpatterned region according to the invention, in particular a patterned region which is formed by a first periodic dot structure in the micro- or submicrometer range with a first interference period in the range from 50 nm to 50 μm, or from a patterned region, which has a first periodic dot structure in the micro- or submicrometer range with a first interference period in the range from 50 nm to 2.0 μm, or from a patterned region which has a first periodic dot structure in the micro- or submicrometer range with a first interference period in the range from 9.5 μm to 50 μm, anti-reflection properties can also be generated.

The inventors of the present invention have discovered that, in addition to the periodicity, the structure depth (i.e. the depth of the inverse cones, measured from the saddle point of the indentation to the apex) also has an influence on the anti-reflection properties (as defined herein). For example, the structure depth or profile depth of the inverse cones (elevations and depressions) is on statistical average in the range of 0.05 μm to 2 μm, preferably in the range of 0.1 μm to 1 μm.

Preferably, an apparatus is used to produce a patterned substrate (5), preferably extensive and/or transparent substrate, which comprises two deflecting elements (6), (7). The deflecting elements (6), (7) are arranged in the optical path (3) of the laser between the beam splitter element (2) and the focusing element (4). The deflecting elements (6), (7) serve to widen the diffraction angle of the at least three, particularly preferably four sub-beams, in which they interfere on the surface or in the interior of the substrate (5), preferably extensive and/or transparent substrate. By adjusting the distances between the optical elements, it can be ensured that only the beam splitter element (2) needs to be movable along its optical axis in order to change the interference period. This enables easier adjustment processes during machining.

In a particularly preferred embodiment, a transparent material is provided as an extensive substrate. Due to the translucency of the transparent material, laser interference processing inside the substrate is possible, preferably with an embodiment of the above-mentioned apparatus.

In a preferred embodiment, an apparatus is used for producing a patterned substrate, preferably extensive and/or transparent substrate, which uses a pulsed laser radiation source (1). In a particularly preferred embodiment, an apparatus for producing a patterned substrate, preferably extensive and/or transparent substrate, is used which has a holding device for the substrate which is freely movable in the xy plane, perpendicular to the optical path (3) of the laser beam emitted by the laser radiation source (1).

The pixel density Pd, i.e. the distance at which an interference pixel of width D can be applied to the substrate, preferably extensive and/or transparent substrate, can be adjusted via the frequency of the laser radiation source (1), f, and the speed of movement of the holding device, v:

$$Pd = v / f$$

If the width of the interference pixel, D, is greater than the pixel density Pd, neighboring interference pixels overlap within an area. This area is known to the skilled person as the pulse overlap, OV. It can be calculated as:

$$OV = ( D - Pd ) / D$$

In a preferred embodiment, in the process for producing a patterned substrate, preferably extensive and/or transparent substrate, Pd is smaller than D. The resulting pulse overlap OV leads to multiple irradiation of the substrate, preferably extensive and/or transparent substrate. Preferably, non-textured surfaces can thus be avoided.

In a particularly preferred embodiment, the same interference pixels are irradiated several times in the process for producing a patterned substrate, preferably extensive and/or transparent substrate. This makes it possible to increase the depth of the resulting microstructures.

The advantage of a patterned substrate, preferably extensive and/or transparent substrate, produced by such a method is the high regularity of the generated periodic dot structures with structure dimensions in the micrometer or submicrometer range. A periodic dot structure produced in this way with dimensions in the micro- or sub-micrometer range preferably has a coefficient of variation (a value resulting from dividing the standard deviation by the average value) of the cone cross-section of 15% or less, more preferably 10% or less, even more preferably 5% or less.

Multiple irradiation of a substrate is particularly suitable for producing hierarchical structures. Multiple irradiation of the same interference pixel causes at least partial melting of the substrate material, whereby a wave structure is formed during the patterning process, i.e. when a laser pulse hits the substrate, as a result of the occurrence of a high intensity region.

The structure, in particular the wave structure, is formed by a self-assembly process. In particular, the wave structure is superimposed on a periodic dot structure in the micro- or sub-micrometer range, which can be generated by means of laser interference patterning. Thus, a hierarchical patterning can be generated in a substrate with one process step. According to a preferred embodiment of the invention, multiple irradiation, preferably 2-fold to 400-fold, in particular 20-fold to 300-fold, particularly preferably 50-fold to 200-fold irradiation of the same interference pixel is therefore carried out on the substrate, whereby a wave structure (as defined herein) is formed, in particular a periodic dot structure is formed from superimposed structures, wherein at least one structure has dimensions in the submicrometer range, in particular a quasi-periodic wave structure, and wherein at least one structure is formed from inverse cones. The time offset between the individual pulses is particularly preferably in the range of the pulse duration of the laser pulse, preferably in the range from 1 fs to 100 ns, particularly preferably in the range from 10 fs to 10 ns, very particularly preferably in the range from 10 fs to 15 ps.

Hierarchical patterning refers to a pattern in which a first structure with dimensions in the micro- or submicrometer range, which corresponds to an interference pattern, is superimposed by a further structure which has dimensions which are below the dimensions of the first structure and which is formed by a self-assembly process. Preferably, the dimensions of the further structure, which is formed by a self-assembly process, are in the range of 1% to 30% of the dimensions of the first structure, which corresponds to an interference pattern.

There are numerous technical areas of application for hierarchical patterns, for example in the production of substrates with hydrophobic or superhydrophobic as well as hydrophilic or superhydrophilic surfaces and substrates with anti-icing or anti-fogging properties in addition to the substrates with anti-reflection properties mentioned at the beginning. Advantageously, a method for producing such hierarchical patterns, as described herein, enables the precise adjustment of the process parameters influencing the structure dimensions by a suitable selection of the laser radiation source and a corresponding displacement of the beam splitter element in the optical path of the laser.

In addition, the method defined herein makes it possible to provide a substrate with hierarchical patterns by means of the same apparatus and, moreover, in the same process step, whereas conventional processes proceed successively, i.e. are not capable of simultaneously generating a first structure with dimensions in the micro- or submicrometer range, which corresponds to an interference pattern, and a further structure, which is formed by a self-assembly process.

Moving the substrate to be patterned, preferably extensive and/or transparent substrate, in the laser beam is comparatively time-consuming and slow due to the relatively large masses moved in the process. It is therefore advantageous to provide the substrate, preferably extensive and/or transparent substrate, in a fixed position during processing and to realize the extensive patterning of the substrate by focusing the sub-beams on the surface or the volume of the substrate by manipulating the laser sub-beams with optical elements (focusing mirrors or galvo mirrors (laser scanners)) in the beam direction. As the masses moved in this process are relatively small, this is possible with far less effort or much faster. Preferably, the substrate is stationary during the process.

The two-dimensional patterning of the substrate is of course also possible in principle by moving the substrate in the laser beam.

Due to the periodic structures in the micro- and/or sub-micrometer range, preferably first periodic dot structures, produced by means of the method disclosed herein, the substrate patterned in this way has anti-fogging properties. This is ensured by the fact that water wetting the substrate does not form droplets and instead runs to form a homogeneous water film, so that the view through or onto the substrate is not obstructed by fogging.

The invention therefore also covers a patterned substrate with anti-fogging properties, which comprises a first periodic dot structure in the micro- and/or submicrometer range, wherein the first periodic dot structure is formed from inverse cones or cones, wherein the inverse cones or cones are arranged periodically with respect to each other at a distance relative to their saddle point or center with an interference period in the range from 50 nm to 2.0 μm and/or in the range from 9.5 μm to 50 μm.

According to a preferred embodiment of the invention, the patterned substrate is obtained by processing with a method as defined herein.

A patterned substrate generated by the method and apparatus disclosed herein is further suitable for further processing by means of a coating process, wherein the substrate may receive a physical and/or chemical coating. Such a coating can enhance the properties of the patterned substrate, for example the anti-reflection properties and/or hydrophilic and/or hydrophobic properties. The application of a chemical spray coating and/or the application of a coating by means of chemical vapor deposition and/or sputtering is conceivable.

The invention thus also comprises a method in which the patterned substrate is coated after patterning according to one of the types of coating mentioned herein. As a result, the patterning, in particular the first periodic dot structure, then also occurs in the coating, but also in the underlying substrate.

### Apparatus

### Laser Radiation Source

The apparatus for generating a patterned substrate with anti-fogging properties comprises a laser radiation source (1) that emits a laser beam. The radiation profile of the emitted laser beam corresponds either to a Gaussian profile or a top-hat profile, particularly preferably a top-hat profile. The top-hat profile is helpful in order to pattern or cover a substrate surface to be structured more homogeneously and, if necessary, to enable a faster patterning rate.

In a particularly preferred embodiment, the laser radiation source (1) is a source that generates a pulsed laser beam. The pulse width of the pulsed laser radiation source is, for example, in the range from 10 femtoseconds to 100 nanoseconds, in particular 50 femtoseconds to 10 nanoseconds, most preferably 50 femtoseconds to less than 100 picoseconds.

Unless expressly stated otherwise, the term laser beam or sub-beam does not refer to an idealized beam of geometric optics, but to a real light beam, such as a laser beam that does not have an infinitesimally small beam cross-section, but an extended beam cross-section (Gaussian distribution profile or an intrinsic top-hat beam).

Top-hat profile or top-hat intensity distribution refers to an intensity distribution that can essentially be described by a rectangular function (rect (x)), at least with regard to one direction. Real intensity distributions that show deviations from a rectangular function in the percentage range or sloping edges are also referred to as top-hat distributions or top-hat profiles. Methods and apparatuses for generating a top-hat profile are well known to those skilled in the art and are described, for example, in EP 2 663 892. Optical elements for transforming the intensity profile of a laser beam are also already known. For example, diffractive and/or refractive optics can be used to transform laser beams with a Gaussian-shaped intensity profile into laser beams that have a top-hat-shaped intensity profile in one or more defined planes, such as a Gauss-to-top hat focus beam shaper from TOPAG Lasertechnik GmbH, see e.g. DE102010005774A1. Such laser beams with top-hat-shaped intensity profiles are particularly attractive for laser material processing, especially when using laser pulses that are shorter than 50 ps, as the essentially constant energy or power density enables particularly good and reproducible processing results to be achieved.

The laser radiation source (1) comprised by the apparatus according to the invention can have an intensity of 0.01 to 5 J/cm², particularly preferably 0.1 to 2 J/cm², very particularly preferably 0.1 to 0.5 J/cm². The apparatus according to the invention allows the intensity of the laser radiation source to be flexibly selected within a range. The beam diameter plays no role in the generation of the interference pattern on the substrate, preferably extensive and/or transparent substrate. Due to the preferred arrangement of the optical elements in the optical path of the laser, no unit is required to control the intensity of the laser beam.

The laser radiation source is preferably configured to emit wavelengths in the range from 200 nm to 15 μm (e.g. CO2 lasers in the range from 10.6 μm), most preferably in the range from 266 nm to 1,064 nm. Suitable laser radiation sources include UV laser beam sources, laser radiation sources (155 to 355 nm) that emit green light (532 nm), diode lasers (typically 800 to 1000 nm) or laser radiation sources that emit radiation in the near infrared (typically 1064 nm), in particular with a wavelength in the range of 200 to 650 nm. Lasers suitable for microprocessing are known to the skilled person and include, for example, HeNe lasers, HeAg lasers (approx. 224 nm), NeCu lasers (approx. 249 nm), Nd: YAG lasers (approx. 355 nm), YAG lasers (approx. 532 nm), InGaN lasers (approx. 532 nm).

According to a further embodiment, the apparatus according to the invention has at least one further laser radiation source which is designed such that it generates a laser beam which interferes with the laser beam of the first laser radiation source or the laser beam of the first laser radiation source, which is divided into sub-beams, in an interference region. The additional laser radiation source has the same properties as described above, although these may be similar to or different from those of the first laser radiation source.

### Optical Elements

The present invention comprises a plurality of optical elements. These elements are primarily prisms and lenses.

These lenses can be refractive or diffractive. Spherical, aspherical or cylindrical lenses can be used. In a preferred embodiment, cylindrical lenses are used. This makes it possible to compress the overlapping areas of the sub-beams (also referred to herein as interference pixels) in one spatial direction and stretch them in another. If the lenses are not spherical/aspherical but cylindrical, this has the advantage that the beams can be deformed at the same time. This allows the processing spot (i.e. the interference pattern created on the substrate) to be deformed from a point to a line containing the interference pattern. With sufficient energy from the laser, this line can be in the range of 10-15 mm long (and approximately 100 μm thick).

Furthermore, Spatial Light Modulators (SLM) can be used for beam shaping. The use of SLMs for spatial modulation of the phase or the intensity or the phase and intensity of an incident light beam is known to the person skilled in the art. The use of Liquid Crystal on Silicon (LCoS) SLMs for beam splitting is described in the literature and is also conceivable in the apparatus according to the invention. In addition, SLMs can also be used to focus the sub-beams on the substrate. Such an SLM can be controlled optically, electronically or acoustically.

All the optical elements described below are arranged in the optical path (3) of the laser. For the purposes of the invention, the optical path of the laser refers to the path of both the laser beam emitted by the laser radiation source and the path of the sub-beams split by a beam splitter element. However, the optical axis of the optical path (3) is understood to be the optical axis of the laser beam emitted by the laser radiation source (1). Unless otherwise explained, all optical elements are arranged perpendicular to the optical axis of the optical path (3).

### Beam Splitter Element

A beam splitter element (2) is located in the optical path (3) of the laser, behind the laser radiation source (1). The beam splitter element (2) can be a diffractive or a refractive beam splitter element. Diffractive beam splitter elements are also referred to as diffractive optical elements (DOE) for short. For the purposes of the invention, a diffractive beam splitter element refers to an optical element which contains microstructures or nanostructures, preferably microstructures, which split an incoming beam into different beams according to the different diffraction orders. For the purposes of the invention, a refractive beam splitter element refers to a beam splitter element in which the beams are split on the basis of refractive index differences at surfaces, these usually being transparent optical elements, such as a prism or a double prism. Preferably, the beam splitter element (2) is a diffractive optical beam splitter element.

According to a preferred embodiment, the beam splitter element is a single optical element, in particular a diffractive or refractive optical element, which is constructed in such a way that the subdivision of the incident laser beam is based on the optical properties of the beam splitter element. This advantageously ensures that a simpler optical structure can be realized compared to a multi-part beam splitter element, which consists of several optical elements (e.g. mirrors, prisms, etc.). The desired beam splitting can be achieved without the need to calibrate or adjust the arrangement of several optical elements in relation to each other. The mobility of the beam splitter element in the optical path is also easy to realize, as only a single optical element needs to be moved. In addition, the use of a one-piece beam splitter element results in less components that are susceptible to wear and may need to be replaced.

According to one possible embodiment, the beam splitter is designed as a polarizing beam splitter, in which one of the resulting beams has a different polarization than the other, or as a non-polarizing beam splitter, in which the polarization plays no role in the splitting of the beam.

In a preferred embodiment, the beam splitter element (2) splits the emitted laser beam into at least 3, preferably at least 4, in particular 4 to 8, i.e. 4, 5, 6, 7 or 8 sub-beams.

In a further embodiment, the beam splitter element (2) splits the emitted laser beam into at least 2, preferably at least 3 to 4, in particular 4 to 10, i.e. 4, 5, 6, 7, 8, 9 or 10 sub-beams. The beam splitter element (2) is freely movable along its optical axis. In other words, it can be moved along its optical axis towards or away from the laser radiation source. The movement of the beam splitter element (2) changes the expansion of the at least 3 sub-beams so that they hit a focusing element at different distances from each other. As a result, the angle θ at which the sub-beams hit the substrate (5), preferably extensive and/or transparent substrate, can be changed. This results in a seamless change in the interference period pₙ from a superposition of four sub-beams to

$$p = \frac{λ}{\sqrt{2} sin θ}$$

where λ is the wavelength of the emitted laser beam.

According to a preferred embodiment of the present invention, the beam splitter element is designed as a rotating element. This advantageously allows the polarization of the sub-beams to be modified.

Particularly preferably, the angle θ at which the partial beams hit the substrate (5), preferably extensive and/or transparent substrate, is 0.1° to 90°.

The angle θ is also dependent on the distances between the optical elements, in particular the distance between the optical elements and the beam splitter element, especially the distance between the focusing element and the beam splitter element. Depending on the desired interference period to be generated on or in the extensive and/or transparent substrate, the position of the beam splitter element can be adjusted or calculated in such a way that the desired interference period can be set. The position of the optical elements comprised by the apparatus, in particular the position of the focusing element in relation to the beam splitter element, is taken into account in such a way that the position of the beam splitter element can be adjusted accordingly if the distance between the optical elements is greater or smaller.

In order to generate a patterned substrate with anti-reflection properties, it has been found to be particularly advantageous if a distance of 10 mm to 50 mm or from 150 mm to 200 nm is set from the beam splitter element (2) to the deflecting element (7).

According to a preferred embodiment of the invention, the apparatus also comprises a measuring device, in particular a measuring device which operates by means of a laser or an optical sensor, which is configured to measure the position of the beam splitter element and, if appropriate, the distance of the beam splitter element from the other optical elements, in particular the position of the focusing element.

Furthermore, the apparatus according to the invention can comprise a control device which is connected to the measuring device in terms of signal technology and which is connected in particular to a computing unit in such a way that the measured position of the beam splitter element can be compared with a first predetermined comparison value, the control device being configured in terms of programming so that, if the distance of the beam splitter element to the other optical elements, in particular the position of the focusing element and/or the deflecting element (7) is greater or smaller than the first predetermined comparison value, then a control signal is generated via the control device, with which at least one position of an optical element, in particular of the beam splitter element (2), is changed in such a way, in particular of the beam splitter element (2) in relation to the deflecting element (7), that the desired interference period is generated on the substrate.

In this context, the method for producing a substrate with a dot structure in the micro- or submicrometer range, in particular after step (a), can also comprise the following steps:
(i) measuring the position of the beam splitter element (2) and, if necessary, the distance of the beam splitter element to the further optical elements or to at least one of the further optical elements, in particular to the position of the focusing element (4) and/or the deflecting element (7),
(ii) comparing the measured position of the beam splitter element with a first predetermined reference value, and
(iii) if the measured distance of the beam splitter element to the other optical elements or to at least one of the other optical elements, in particular to the position of the focusing element (4) and/or the deflecting element (7), is greater or smaller than the first predetermined reference value: changing the position of the optical element, in particular of the beam splitter element (2) (in particular in relation to the other optical elements, especially preferably of the beam splitter element (2) in relation to the deflecting element (7)), in such a way that the desired interference period is produced on the substrate.

The laser beam division within the beam splitter element (2) can be conducted either by a partially reflective beam splitter element, for example a semi-transparent mirror, or by a transmissive beam splitter element, for example a dichroic prism.

In a preferred embodiment, further beam splitter elements are arranged in succession of the beam splitter element (2) in the optical path of the laser. These beam splitter elements are arranged in such a way that they split each of the at least three sub-beams into at least two further sub-beams. This allows a higher number of sub-beams to be generated, which are directed onto the substrate, preferably extensive and/or transparent substrate, so that they interfere on the surface or inside the substrate. This allows the interference period of the interference pattern to be adjusted.

### Focusing Element (4)

Furthermore, a focusing element (4) is arranged in succession of the beam splitter element (2) in the optical path (3) of the laser, which is configured so that the sub-beams pass through it in such a way that the sub-beams interfere on the surface or inside a substrate (5) to be structured in an interference region. The focusing element (4) focuses the at least three sub-beams in a spatial direction without focusing the at least three sub-beams in the spatial direction perpendicular thereto. For example, the focusing element (4) can be a focusing optical lens. In the context of the invention, focusing means bundling the at least three sub-beams on the surface or inside a substrate, preferably extensive and/or transparent substrate.

The focusing element (4) can be freely movable in the optical path (3). According to a preferred embodiment of the present invention, the focusing element (4) is fixed in the optical path or along the optical axis.

It is understood that the optical elements defined herein can, for example, be arranged in a common housing for beam splitting and for aligning the sub-beams in the direction of a substrate to be structured accordingly.

In a preferred embodiment, the focusing element (4) is a spherical lens. The spherical lens is configured so that the incident at least three sub-beams pass through it in such a way that they interfere in an interference region on the surface or inside the substrate (5) to be structured, preferably extensive and/or transparent substrate. The width of the interference region is preferably 1 to 600 μm, particularly preferably 10 to 400 μm, most preferably 20 to 200 μm. In this way, a high patterning rate, for example as defined herein, can be set at the same time.

In a particularly preferred embodiment, the focusing element (4) is a cylindrical lens. The cylindrical lens is configured so that the area in which the at least three sub-beams overlap on the surface or inside the substrate (5), preferably extensive and/or transparent substrate, is stretched in a spatial direction. As a result, the area of the substrate on which the interference pattern can be generated takes on an elliptical shape. The large half-axis of this ellipse can reach a length of 20 μm to 15 mm. This increases the area that can be structured within one irradiation.

### First Deflecting Element

In a particularly preferred embodiment, a deflecting element (7) is located before the focusing element (4) and in succession of the beam splitter element (2), which is preferably arranged in the optical path (3) of the laser. This deflecting element (7) is used to widen the distances between the at least three sub-beams and can thus also change the angle at which the sub-beams hit the substrate (5), preferably extensive and/or transparent substrate. It is configured so that it increases the divergence of the at least three sub-beams and thus moves the area in which the at least three sub-beams interfere along the optical axis of the optical path (3) away from the laser radiation source (1).

In the context of the invention, widening the distances between the at least three sub-beams is understood to mean that the angle of the respective sub-beams to the optical axis of the laser beam emitted by the laser radiation source (1) is increased.

The widening and the resulting deflection of the sub-beams has the advantage that the sub-beams can be bundled more strongly by the focusing element (4). This results in a higher intensity in the area in which the at least three sub-beams interfere on the surface or inside the substrate (5), preferably extensive and/or transparent substrate.

The appropriate choice of deflecting element means that a unit for controlling the intensity of the laser beam can be dispensed with. In a preferred embodiment of the apparatus, a deflecting element (7) is used which, by expanding the at least three sub-beams, allows the at least three sub-beams to be focused on the substrate (5) by means of a focusing element (4), whereby the intensity of the interference points on the surface or inside the substrate, preferably extensive and/or transparent substrate, can be achieved without additional adjustment of the intensity of the laser radiation source (1). This has the advantage that laser radiation sources with low intensity (power per area) can also be used for patterning the substrate while generating the periodic dot structure, whereby the optical elements are protected against wear and lower structure depths are easier to generate.

### Further Deflecting Element

Furthermore, it can be provided that a further deflecting element (6) is arranged in succession of the beam splitter element (3) in the optical path (3) of the laser radiation source (1), which deflects the sub-beams in such a way that they run essentially parallel to one another after emerging from the further deflecting element (6). As a result, the apparatus can be configured so that the processing point, i.e. the point at which the at least three sub-beams interfere on the surface or inside the substrate, preferably extensive and/or transparent substrate, remains constant when the beam splitter element is moved in the optical path of the laser along its optical axis. The term “essentially parallel” should be understood in the context of this document to mean an angular offset of between +15° and −15°, in particular only between +10° and −10°, very preferably between +5° and −5° between the two sub-beams, though in particular of course not an angular offset of 0°.

The further deflecting element (6) can be a conventional refractive lens. Alternatively, however, the further deflecting element (6) can also be designed as a diffractive lens (e.g. Fresnel lens). Diffractive lenses have the advantage that they are considerably thinner and lighter, which simplifies miniaturization of the apparatus disclosed herein.

By appropriately selecting the refractive indices of the optical elements (4), (6) and (7), the distances between the optical elements and the substrate as well as the interference period p can be adjusted. All optical elements, with the exception of the beam splitter element (2), can preferably be fixed within the optical path (3) of the laser. This particularly preferred embodiment therefore offers the advantage that only one element, namely the beam splitter element (2), needs to be moved to adjust the interference region or the interference angle. This saves process steps when configuring the apparatus, such as calibrating the apparatus to the desired interference period. Furthermore, a fixed setting, i.e. where preferably all optical elements are fixed within the optical path (3) of the laser, prevents wear of the optical elements.

### Polarization Element

In a further embodiment, a polarization element (8) is located behind the deflecting element, particularly preferably in a setup with two deflecting elements (6), (7) behind the further deflecting element (6), and in front of the focusing element (4) in at least one of the optical paths of the at least 3 sub-beams there is one polarization element per sub-beam. The polarization elements can modify the polarization of the sub-beams relative to one another. This allows the resulting interference pattern, which the at least 3 sub-beams map on the surface or in the volume of a substrate, preferably extensive and/or transparent substrate, to be modified. By arranging a polarization element (8) in at least one of the optical paths of the sub-beams, preferably not in each optical path of the sub-beams, preferably in an optical path up to (n-1) optical paths, where n is the number of sub-beams generated in the application process, the polarization plane of at least one sub-beam in the beam path can be advantageously rotated and thus the pattern of an interference pixel in the plane of the substrate can be “disturbed”.

In particular, the interfering sub-beams can therefore be non-polarized, linearly polarized, circularly polarized, elliptically polarized, radially polarized or azimuthally polarized.

### Optical Element for Beam Shaping

In a further embodiment, the laser radiation source (1) has a radiation profile that corresponds to a Gaussian profile as described above. In such an embodiment, a further optical element for beam shaping can be located behind the laser radiation source (1) and in front of the beam splitter element (2). This element is used to adjust the radiation profile of the laser radiation source to a top-hat profile.

An optical element with a concave parabolic or planar reflective surface can also be provided in the apparatus according to the invention, whereby the optical element is designed to be rotatable about at least one axis or displaceable along the optical path (3), for example. As a result, an additional focusing element (4) positioned in the optical path (3) or an additional deflecting element (6) can be dispensed with if necessary. For example, this optical element can be used to direct laser beams or laser sub-beams onto the surface of the focusing element (4) or another focusing optical element before the beams reach the substrate to be patterned to form structure elements.

Alternatively, for example, at least one optical element with a concave parabolic or planar reflective surface can also be provided, which is designed to be rotatable about at least one axis or displaceable along the optical path (3), for example, this optical element being positioned in succession of the first deflecting element (7) and the further deflecting element (6) in the optical path. For example, the sub-beams can be deflected in the optical path (deflecting mirror) or focused in the optical path in such a way that the substrate to be patterned can be positioned in a fixed position during processing (so-called focusing mirror or galvo mirror (laser scanner) (9)).

An embodiment comprising a polygon scanner is also conceivable. In this embodiment, at least one optical element comprises a periodically rotating prism, preferably a periodically rotating mirror prism, in particular a polygon mirror or polygon wheel, as well as a focusing element (4) arranged in succession of the periodically rotating prism in the optical path. The focusing element is configured so that the sub-beams pass through it in such a way that the sub-beams interfere on the surface or inside a substrate (5) to be patterned in an interference region. In a preferred embodiment, the optical element further comprises at least one further deflecting element, for example a reflective deflecting element for deflecting the sub-beams in the optical path. The at least one further deflecting element can be arranged preceding and/or in succession of the periodically rotating prism in the optical path. The at least one further deflecting element is arranged preceding of the focusing element in the optical path.

Such a setup advantageously allows a surface of a substrate to be scanned quickly, so that a high patterning rate of up to 3 m²/min, in particular in the range of 0.05 to 2 m²/min, especially preferably in the range of 0.1 to 1 m²/min, most preferably in the range of 0.1 to 0.9 m²/min can be achieved. The exact patterning rate depends in particular on the available laser power. With future technologies that have a higher laser power, even higher patterning rates can therefore be achieved.

### Holding Device for the Substrate

In a further embodiment, the substrate (5), preferably extensive and/or transparent substrate, is movable in the xy plane. By moving the substrate (5), preferably extensive and/or transparent substrate, in the xy plane, extensive processing by means of laser interference patterning can be ensured. In each processing step (i.e. laser pulse that hits the substrate to be patterned), an interference pixel (as defined herein) is generated, which has a size D depending on the angle of incidence and the intensity distribution of the laser beam, as well as the focusing properties of the optical elements. The distance between the different interference pixels, the pixel density Pd, is determined by the repetition rate of the laser radiation source (1) and the movement of the substrate in relation to the focusing point of the optical elements, i.e. the point at which the interference region is generated on the surface or inside the substrate. If the pixel density Pd is smaller than the size of the interference pixels D, homogeneous processing over a large area is possible.

By moving the substrate in relation to the focusing point (which generates the interference pixel) in combination with pulsed laser (sub-) beams, an extensive, optionally homogeneous and periodic dot structure can be generated on the surface or inside a substrate, preferably extensive and/or transparent substrate.

As an alternative to moving the substrate in relation to the focusing point, the focusing point can also be moved over the sample or the substrate (e.g. using scanner-based methods).

Moving the substrate to be patterned, preferably extensive and/or transparent substrate, in the laser beam can be comparatively time-consuming and slow due to the relatively large masses moved in the process. It is therefore advantageous to provide the substrate, preferably extensive and/or transparent substrate, in a fixed position during processing and to realize the extensive patterning of the substrate by focusing the sub-beams on the surface or the volume of the substrate by manipulating the sub-laser beams with optical elements (focusing mirrors or galvo mirrors (laser scanners)) in the beam direction. As the masses moved in this process are relatively small, this is possible with far less effort, which is to say much faster. Preferably, the substrate is stationary during the process.

### Use of the Patterned Substrate

The patterned substrate with anti-fogging properties defined herein is used, for example, in photovoltaic systems, whereby the efficiency of these photovoltaic systems can be significantly increased by introducing anti-fogging properties. A major challenge in the field of photovoltaic systems lies in the large weather-related losses due to soiling and/or fogging of the surfaces of the systems. On average, reflections cause 40% energy/power losses per system. The efficiency of photovoltaic systems must therefore be constantly improved. One of the most promising approaches is the reduction from weather-related failures with the help of anti-fogging coatings and/or texturing of the surface. The use of the process disclosed herein simplifies, accelerates and improves the treatment of surfaces and guarantees increased durability of the structures.

In addition, the inventors have found that the substrate and method defined herein are suitable for patterning window panes (as another example of anti-fogging glazing). Thus, the patterned substrates disclosed herein can be used, for example, in the form of anti-fogging glazing or as a film coating on house facades, preferably with flat and transparent substrates, as transparent glazing which can be used, for example, to ensure unrestricted viewing conditions in poor weather conditions.

In addition, a reduction in the formation of fogging in microscopes and telescopes can increase the contrast of the images recorded with them, thereby increasing the efficiency and use of these optical devices. The present invention therefore also includes the use of a patterned substrate defined herein as an optical element with a periodic dot structure in the micrometer and/or submicrometer range in optical devices, such as microscopes and telescopes, for which beam guidance, beam shaping, beam bundling and/or beam focusing are essential.

It is also expedient to use the patterned substrate defined herein as a negative form (so-called master), for example within an embossing process for the indirect application or generation of structures on another substrate. This is relevant, for example, in roll-to-roll processes in which structures are transferred from a master (usually metal such as nickel) to a polymer film (e.g. PET) in a continuous process using a hot or UV embossing process. This allows the inverse structures to be produced on other substrates in high throughput as periodic dot structures in the micro- and/or sub-micrometer range.

The apparatus according to the invention and the method according to the invention also offer the possibility of producing a flat and transparent substrate with hydrophilic or superhydrophilic properties without great technical effort. A substrate patterned in this way has a wide range of applications in areas in which the homogeneous wetting properties of hydrophilic and or superhydrophilic substrates are desired, for example in the field of automotive components, displays or glazing, but also in the field of aviation or antenna technology. In particular, the anti-fogging properties of the substrate according to the invention are advantageous in these areas, since fogging of glazing is particularly undesirable in the aforementioned areas.

Furthermore, the method according to the invention and the apparatus according to the invention also offer the possibility of producing a patterned substrate which is suitable for further processing, for example chemical and/or physical treatment, in particular for coating by means of a chemical spray coating, in order to increase and/or modify the resulting anti-fogging properties and hydrophilic or superhydrophilic properties and/or anti-reflection properties of the substrate.

### LIST OF REFERENCE SIGNS

1 laser radiation source
2 beam splitter element
3 optical path
4 focusing element
5 substrate
6 further deflecting element
7 deflecting element
8 polarization element
9 focusing mirror or galvo mirror
31 optical axis
91 polygon wheel
10 first interference pixel
11 second interference pixel
12 third interference pixel
13 fourth interference pixel
14 inverse cones
14.1 inverse cones of the first interference pixel
14.1 inverse cones of the second interference pixel
14.1 inverse cones of the third interference pixel
14.1 inverse cones of the fourth interference pixel
15 offset
16 dot structure
P1 first interference period
p2 second interference period
19 quasi-periodic wave structure
20 wave crest
21 wave trough
22 defect
23 water contact angle
24 liquid
25 gaseous phase
26 tangent
28 patterned region
29 unpatterned region
A-A cutting line

### EXAMPLES OF EMBODIMENTS

The present invention is explained in more detail using the following figures and examples of embodiments, without limiting the invention to these. In particular, features shown in the individual figures and described for the respective example are not limited to the respective individual example.

Herein shows

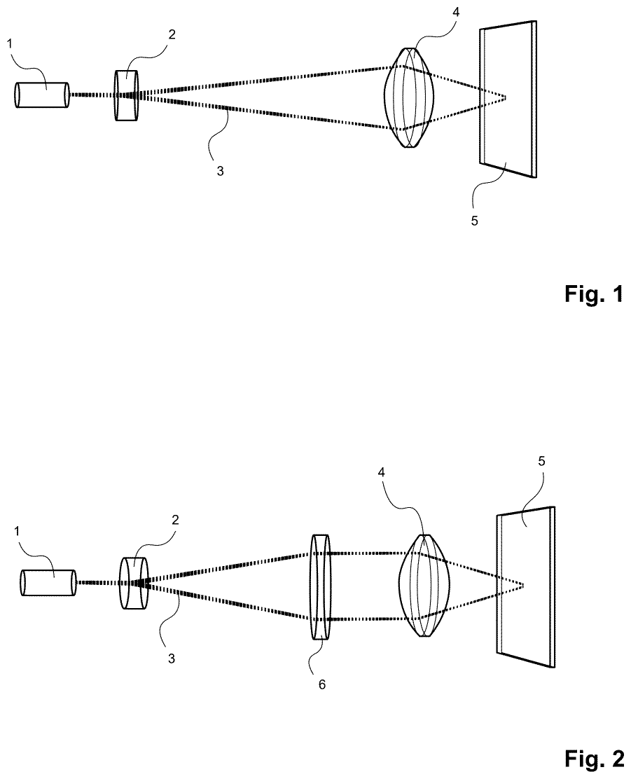

FIG. 1: a schematic perspective view of an apparatus for carrying out the method according to the invention.

FIG. 2: a schematic perspective view of an apparatus for carrying out the method according to the invention, which contains a deflecting element (6) for parallelizing the partial beams.

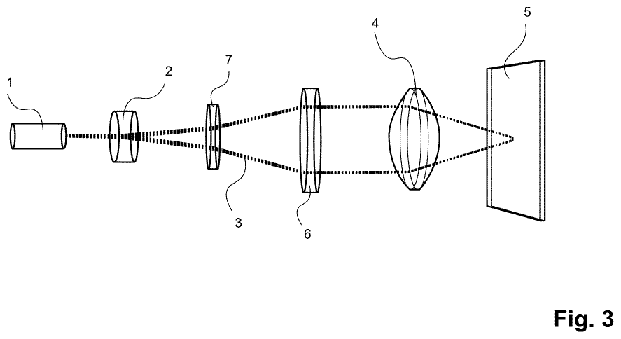

FIG. 3: a schematic perspective view of an apparatus for carrying out the method according to the invention, which contains a deflecting element (7) for widening the angle of the partial beams relative to the optical axis of the beam path (3).

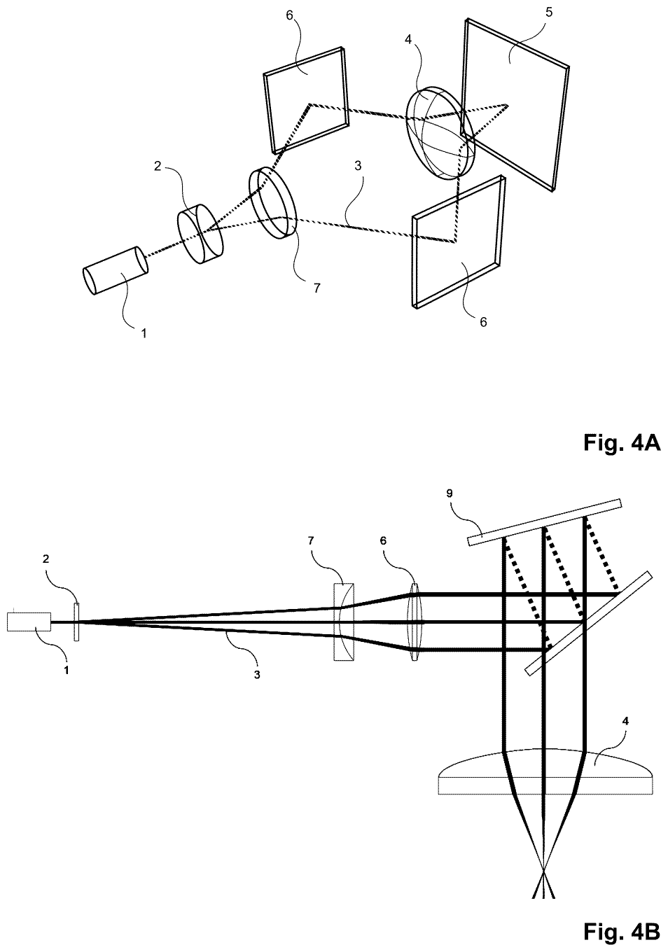

FIG. 4A: a schematic perspective view of an apparatus for carrying out the method according to the invention, which contains optical elements (6) with a planar, reflective surface which deflect the partial beams onto the focusing element (4).

FIG. 4B: a schematic perspective view of an apparatus for carrying out the method according to the invention, which comprises a galvo mirror (9) as an optical element for beam shaping, which permits stationary positioning of the substrate to be patterned during the patterning process.

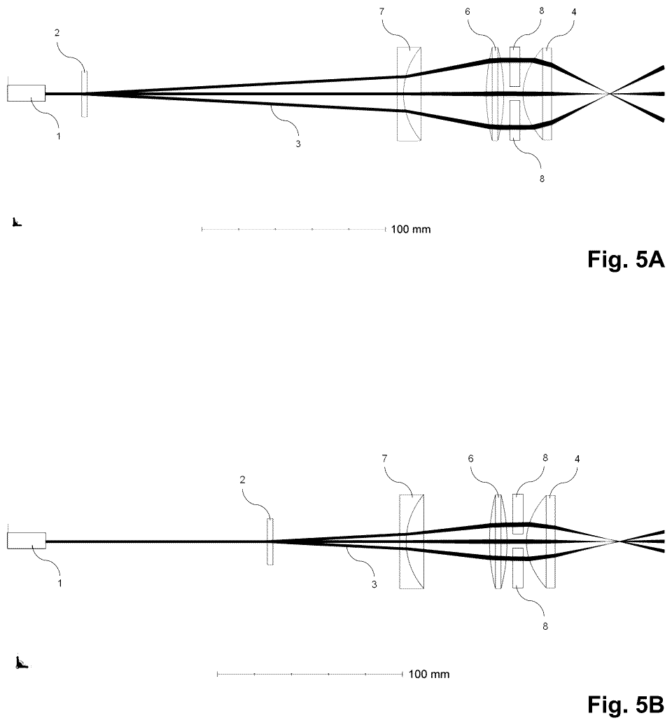

FIG. 5: a schematic perspective view of an apparatus for carrying out the method according to the invention, wherein the apparatus contains a polarization element (8) which shifts the phase course of the partial beams relative to one another, wherein
a) the beam splitter element (2) is positioned in the beam path (3) close to the laser radiation source (1).
b) the beam splitter element (2) is positioned close to the deflecting element (7) in the beam path (3).

FIG. 6: a schematic view of the interference pixels resulting on the surface or inside the substrate with the width D, and the distribution of the individual interference pixels on the surface or inside the substrate, the interference pixels being shifted relative to one another with the pixel density Pd.

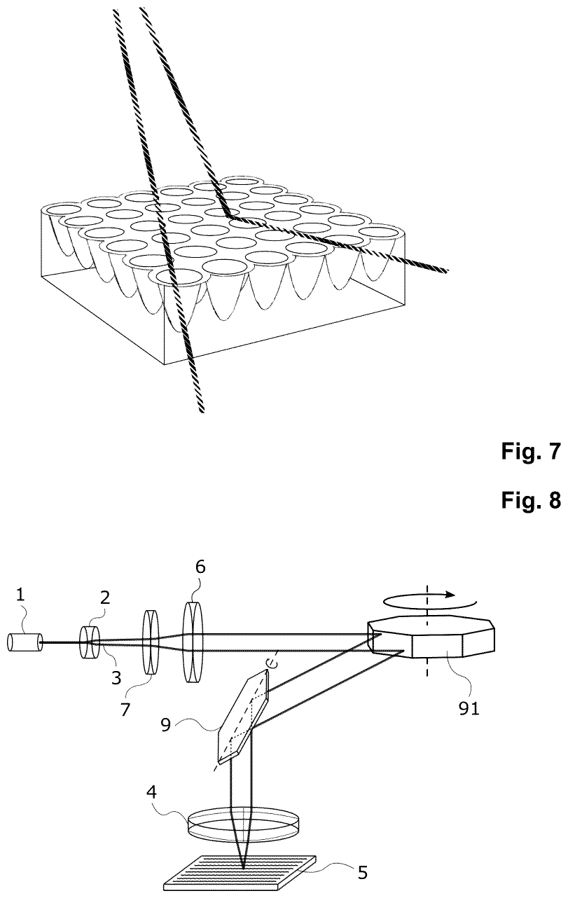

FIG. 7: a schematic perspective view of the patterned substrate (5) with the generated periodic dot structures, consisting of inverse cones, with dimensions in the micro- and submicrometer range, and symbolically the transmission of incident electromagnetic waves with wavelengths greater than the interference period of the generated structures, as well as the diffraction of incident electromagnetic waves with wavelengths in the range of or smaller than the generated structures.

FIG. 8: a schematic perspective view of an apparatus for carrying out the method according to the invention, which contains as an optical element a galvo mirror (9) with a planar, reflective surface, which deflects the partial beams onto the focusing element (4), and a polygon wheel (91).

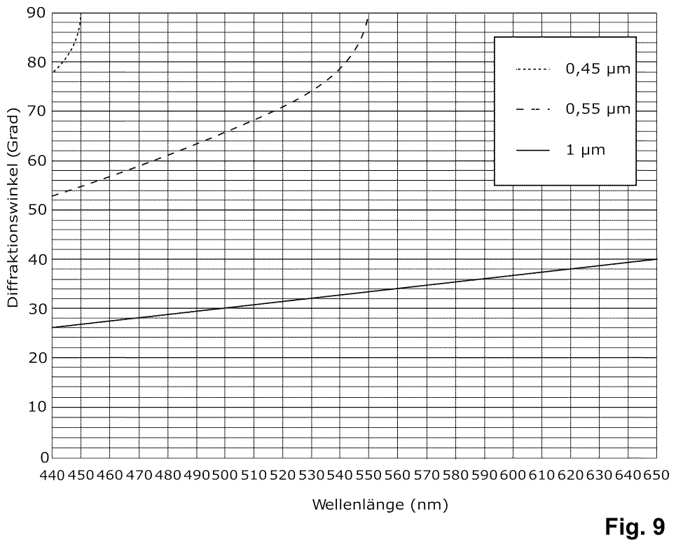

FIG. 9: A graphical representation of the angle of diffraction of incident light versus the wavelength of the incident light for patterned substrates with three different structure widths.

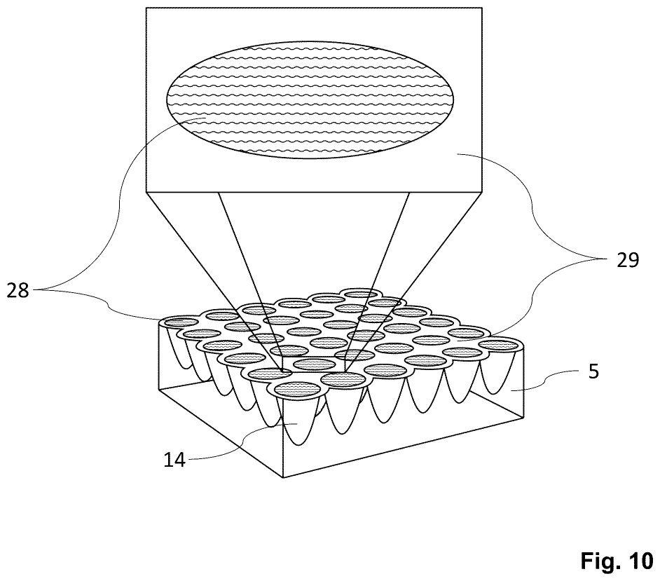

FIG. 10: a schematic perspective view of the patterned substrate (5) with the generated periodic dot structures, consisting of inverse cones, with dimensions in the micrometer range, on which a quasi-periodic wave structure in the submicrometer range is superimposed.

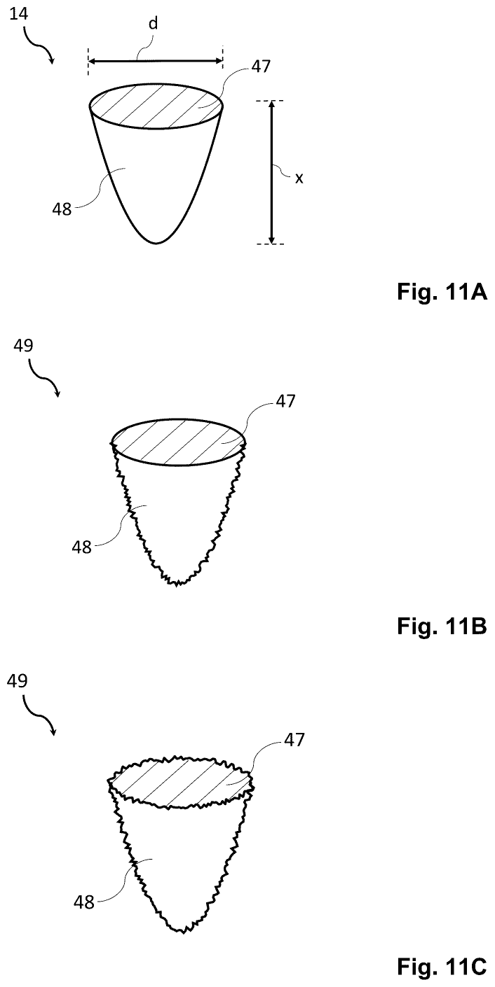

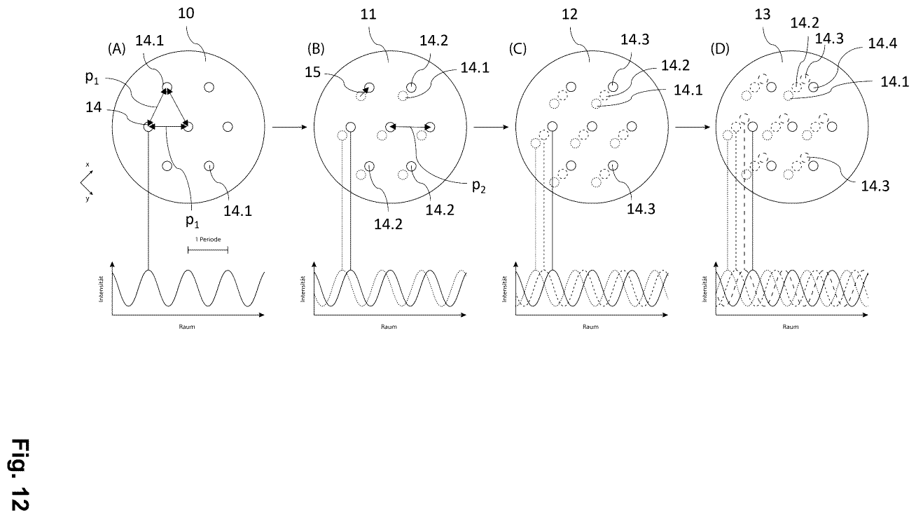

FIG. 11A: a schematic view of an inverse cone.

FIG. 11B: a schematic view of a cone-like depression with a circular base.

FIG. 11C: a schematic view of a cone-like depression with an irregular base.

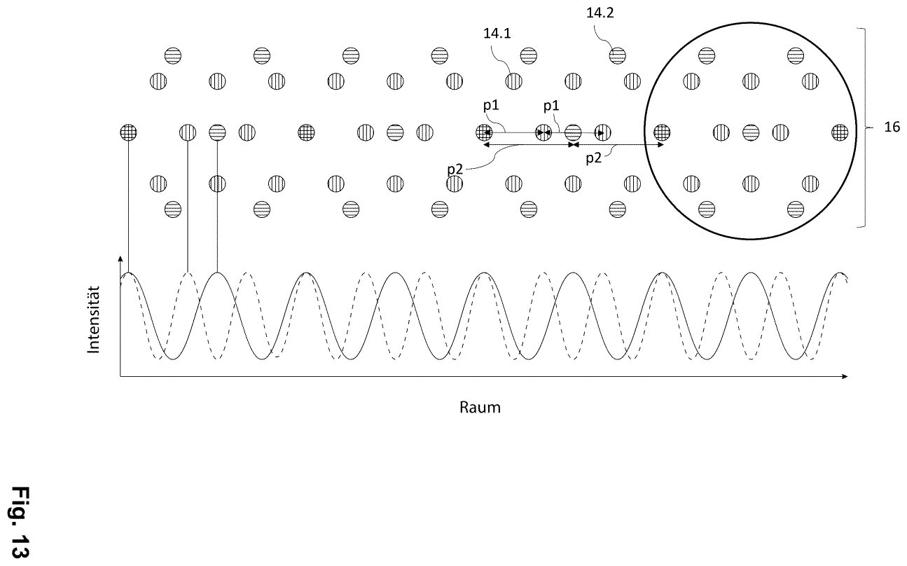

FIG. 12: a cumulative build-up of the dot structure from a superposition of several interference pixels.

FIG. 13: a dot structure formed by the superposition of several first and second interference pixels.

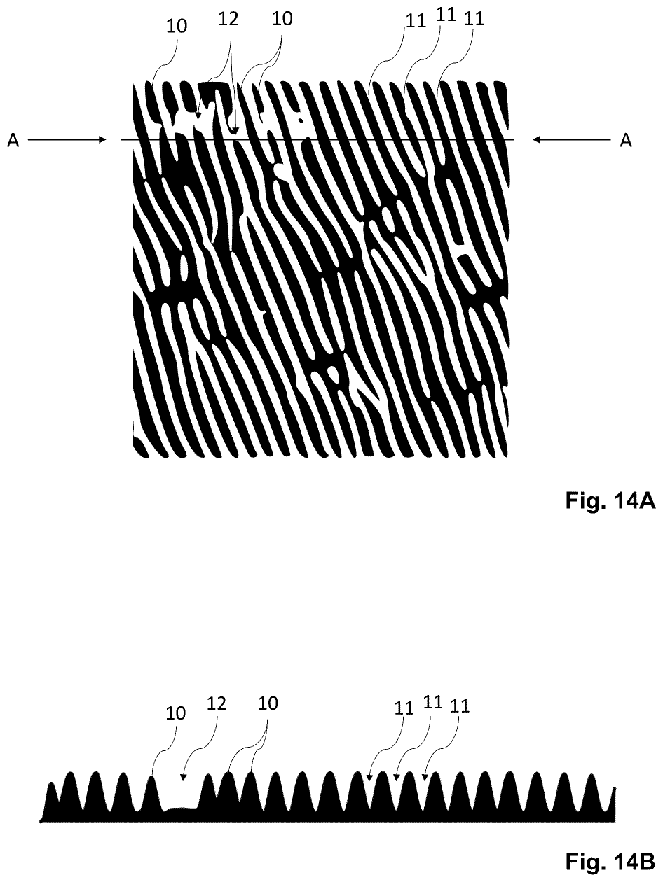

FIG. 14: a schematic
a) plan view and
b) a sectional view of a quasi-periodic wave structure in the submicrometer range.

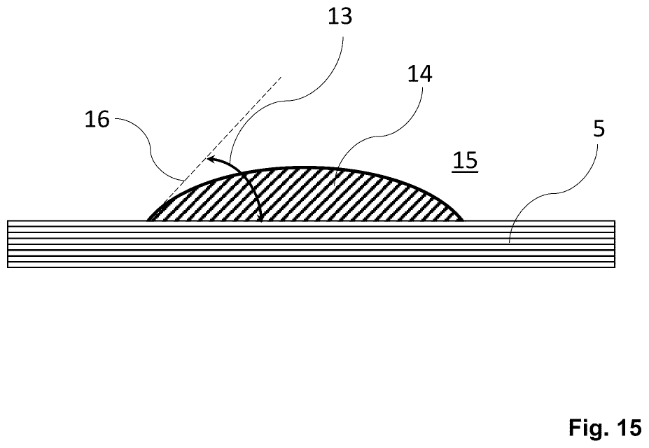

FIG. 15: a visualization of the water contact angle

FIG. 1 visualizes in a first embodiment example an apparatus as used in the method according to the invention for patterning a substrate with anti-fogging properties, comprising a laser radiation source (1) for emitting a laser beam. A beam splitter element (2), which is movably arranged in the optical path (3) of the laser beam behind the laser radiation source (1), is located in the beam path (3). A focusing element (4) is located in the optical path (3) of the laser beam behind the beam splitter element (2). A holding device, on which a substrate (5), preferably extensive and/or transparent substrate, is mounted, is arranged in the optical path (3) of the laser beam behind the focusing element (4).

In this embodiment, the laser radiation source (1) emits a pulsed laser beam. In this case, the laser radiation source is a UV laser with a wavelength of 355 nm and a pulse duration of 12 ps. In this embodiment, the radiation profile of the laser radiation source corresponds to a top-hat profile.

In this embodiment, the beam splitter element (2) corresponds to a diffractive beam splitter element. A diffractive beam splitter element here is a beam splitter element that contains micro- or nanostructures. The beam splitter element (2) divides the laser beam into 4 sub-beams.

In this embodiment, the focusing element (4) corresponds to a refractive, spherical lens that directs the sub-beams, which run essentially parallel to each other, onto the substrate (5), preferably extensive and/or transparent substrate, in such a way that they interfere there in an interference region. In this embodiment, the interference angle corresponds to 27.2°, resulting in a interference period of 550 nm for the periodic dot structure in the same polarization state.

According to this embodiment example, the extensive substrate is irradiated once, resulting in a processing time per structural unit, i.e. per interference pixel, of 12 ps.

The substrate (5), preferably extensive and/or transparent substrate, is a glass, in particular a quartz glass, which is mounted on a holding device so that it can be moved in the xy plane, perpendicular to the optical path of the laser beam emitted by the laser radiation source (1).

FIG. 2 visualizes in a further embodiment the apparatus as described in FIG. 1, additionally comprising a deflecting element (6), which is located in the optical path (3) of the laser after the beam splitter element (2) and the focusing element (4).

In this embodiment, the deflecting element is a conventional, refractive, convex lens. The sub-beams hit the deflecting element (6) in such a way that they are essentially parallel to each other after passing through the deflecting element. This allows the point at which the sub-beams interfere on the surface or inside the substrate to be adjusted.

FIG. 3 visualizes in a further embodiment an apparatus based on the setup shown in FIG. 1 and FIG. 2. In addition, this setup comprises a further deflecting element (6), which is arranged in the optical path (3) of the laser between the beam splitter element (2) and the deflecting element (7).

In this embodiment, the further deflecting element (7) is a conventional, refractive, concave lens. The sub-beams hit the further deflecting element in such a way that their angle to the optical axis of the optical path is widened. This allows the interference angle with which the sub-beams interfere on the surface or inside the substrate, preferably extensive and/or transparent substrate, to be changed.

In this embodiment, all optical elements apart from the beam splitter element (2) are fixed along the optical axis of the optical path (3). The interference angle of the sub-beams on the substrate is set by moving the beam splitter element (2) along the optical axis of the optical path.

FIG. 4A shows in a further embodiment an apparatus as in FIG. 3, comprising the optical elements (6) with a planar, reflective surface, which are configured so that they deflect the sub-beams onto the focusing element (4).

In this embodiment, the at least three sub-beams are deflected onto the substrate at a preferred angle by shifting the optical elements (6). This means that a deflecting element in the form of a lens (reference sign (6) in FIG. 3) can be dispensed with.

FIG. 4B shows a schematic perspective view of a device according to the invention, which comprises a galvo mirror (9) as an optical element for beam shaping, which allows stationary positioning of the substrate to be structured during the structuring process.

FIG. 5 visualizes in a further embodiment an apparatus as in FIG. 3, additionally comprising one polarization element (8) per sub-beam, which are arranged in the optical path (3) of the laser beam between the deflecting element (6) and the focusing element (4).

The polarization element is arranged in such a way that it changes the polarization of the individual sub-beams in relation to each other in such a way that a change in the interference pattern results.

This embodiment is shown in two different configurations. In FIG. 5a), the beam splitter element (2) is positioned close to the laser radiation source (1) in the optical path (3). In FIG. 5b), the beam splitter element (2) is positioned close to the deflecting element (7) in the optical path (3). In this way, the interference pattern of the interfering sub-beams on the surface of the substrate (5) can be infinitely adjusted without having to move the other optical elements in the setup or the substrate.

It would also be conceivable for the arrangement to contain an additional optical element for beam shaping, which is arranged in succession of the laser radiation source (1) in the optical path (3) of the laser beam. In this embodiment, the radiation profile of the laser radiation source corresponds to a Gaussian profile. The optical element for beam shaping converts this profile into a top-hat profile.

FIG. 6 contains a schematic view of the interference pixels resulting on the surface or inside the substrate with the width D, and the distribution of the individual interference pixels on the surface or inside the substrate, whereby the interference pixels are shifted relative to one another with the pixel density Pd.

In this embodiment, the pixel density Pd is smaller than the width of an interference pixel, D. Thus, by moving the substrate (5) by means of a pulsed laser beam, an extensive homogeneous periodic dot structure can be generated on the surface or in the interior of a substrate, preferably extensive and/or transparent substrate.

FIG. 7 visualizes the patterned substrate (5) produced by the method according to the invention with the generated periodic dot structures, consisting of inverse cones, with dimensions in the micro- and submicrometer range. The transmission of incident electromagnetic waves with wavelengths greater than the interference period of the generated structures and the diffraction of incident electromagnetic waves with wavelengths in the range of or smaller than the generated structures are also symbolically illustrated.

FIG. 8 shows in a further embodiment an apparatus as in FIG. 4B, comprising the optical element (91) with a planar, reflective surface, which is a polygon wheel that is configured so that it rotates about a marked axis. The incident sub-beams are deflected in such a way that they hit a galvo mirror (9), which directs the beams onto the substrate via a focusing element (4). The rotation of the polygon wheel causes the point at which the beams are focused on the substrate to move along a line during the exposure process. The sub-beams therefore scan the substrate, which leads to an increased process speed.

FIG. 9 shows a graphical representation of the transmission and diffraction capability of a patterned substrate as a function of the structure width. The diffraction angle of light is shown as a function of its wavelength for structures with three different structure widths. If the wavelength of the incident light is greater than the structure width, the light is completely transmitted. At wavelengths in the range of the structure width or smaller, diffraction occurs. The diffraction angles can be taken from the diagram.

FIG. 10 visualizes the patterned substrate (5) generated by the method according to the invention with the generated periodic dot structures, consisting of inverse cones 14, with dimensions in the micrometer range. Superimposed on this periodic dot structure in the micrometer range is a quasi-periodic wave structure in the submicrometer range, which can also be generated by the method according to the invention described herein in a production step by means of multiple irradiation or a high laser pulse energy. A patterned region 28 consists of the structures present on the surface, in particular the inverse cones 14 and the superimposed quasi-periodic line structures. An unpatterned region 29 consists of the section of the surface that has no patterned regions, in particular no inverse cones 14 and no line patterns.

FIG. 11A shows a schematic view of an inverse cone 14 generated by means of a laser interference process, which has the structure depth x. The base surface 47 of the inverse cone 14 is circular with a diameter d. The side surfaces 48 are smooth.

A schematic representation of a cone-like depression 49, such as can be generated by means of an etching process using a mask with circular openings, not shown here, is shown in FIG. 11B. Although the base surface 47 shown is circular, the side surfaces 48 are irregular in shape.

FIG. 11C shows a schematic view of a cone-like depression 49 with an irregular base surface 47 and irregular, completely variable side surfaces 48. Such a depression is generated, for example, during etching without a mask.

FIG. 12 visualizes the cumulative build-up of the dot structure from a superposition of several interference pixels (10, 11, 12, 13). Each interference pixel (10, 11, 12, 13) consists of several inverse cones (14) introduced into the substrate by means of laser interference patterning.

Subfigure (A) shows the first interference pixel (10), which has several inverse cones (14, 14.1). Subfigure (B) visualizes a superposition of the first interference pixel (10) and the second interference pixel (11), this superposition consisting of inverse cones (14.1) of the first interference pixel (10) and inverse cones (14.2) of the second interference pixel (11).

There is an offset (15) between the first interference pixel (10) and the second interference pixel (11), whereby the inverse cones (14.2) of the second interference pixel (11) are displaced by this offset (15) relative to the inverse cones (14.1) of the first interference pixel (10).

Subfigure (C) visualizes a superposition in which a third interference pixel (12) is additionally superimposed with the first two interference pixels (10, 11). The superimposed structure in subfigure (C) thus comprises inverse cones (14.1) of the first interference pixel (10), inverse cones (14.2) of the second interference pixel (11) and inverse cones (14.3) of the third interference pixel (12). In this embodiment example, the third interference pixel (12) is displaced relative to the second interference pixel (11) in the same spatial direction along the x-axis as the second interference pixel (11) is displaced relative to the first interference pixel (10).

Subfigure (D) shows a superimposition in which a fourth interference pixel (13) is also superimposed, whereby this is shifted in a different spatial direction along the y-axis with respect to the third interference pixel (12). Thus, the section in partial image (D) comprises a point structure consisting of a superposition of four interference pixels (10, 11, 12, 13).

The graphs, which are arranged below the interference pixels (10, 11, 12, 13), are used to visualize the periodic structures within an interference pixel (10, 11, 12, 13). Due to the formation of the interference pixels (10, 11, 12, 13) via the process of laser interference patterning, i.e. corresponding to the interference image of the laser (partial) beams, each individual interference pixel (10, 11, 12, 13), which has been formed within an illumination or irradiation process within a selected pulse duration, has a periodic arrangement of the inverse cones (14). The spacing of the inverse cones (14.1) of the first interference pixel (10), which results from the spacing of the intensity maxima of the interference image generating the first interference pixel (10), represents the interference period (p₁). The intensity corresponds to the intensity required to generate the inverse cones (14.1) in the interference pattern of the laser (partial) beams. Thus, the distance between the intensity maxima of the interference image corresponds to the interference period (p1). The second interference pixel (11) has a second interference period (p₂).

FIG. 13 shows a dot structure (16), which is formed from the superposition of several first interference pixels (10) with a first interference period (p₁) and several second interference pixels (11) with a second interference period (p₂). The first interference pixels (10) have inverse cones (14.1), which are shown here with a vertical pattern fill. The second interference pixels (11) have inverse cones (14.2), which are shown with a horizontal pattern fill. The interference period (p₁) of the first interference pixel (10) is smaller than the second interference period (p₂) of the second interference pixel (11).

In an optional setting of the interference pixels (10, 11) such that the number of inverse cones (14.1, 14.2) within the interference pixels (10, 11) is identical, the area of the interference pixels (10, 11) consequently varies, which is visualized here by the circles. One of the first interference pixels (10) is schematically represented here by all inverse cones (14.1) with vertical pattern filling within the smaller circle. One of the second interference pixels is again visualized by the inverse cones (14.2), which are shown with a horizontal pattern structure, within the larger circle.

In this case, the plurality of first interference pixels (10) are arranged adjacent to one another with a repetitive offset and the plurality of first interference pixels (10) thus form a pattern with the interference period (p₁). Furthermore, the plurality of second interference pixels (11) are arranged adjacent to each other in a repetitive offset manner and the plurality of second interference pixels (11) thus form a pattern with the second interference period (p₂) which differs from the first interference period (p₁).

The graph below the dot structure (16) visualizes the arrangement of the inverse cones (14.1, 14.2) along a line through the dot structure (16). The maxima of the intensity correspond to the center of the inverse cones (14.1, 14.2). As in FIG. 12, this graph serves to illustrate the principle. The intensity corresponds to the intensity required to generate the inverse cones (14.1, 14.2) in the interference pattern of the laser (partial) beams.

FIG. 14A visualizes a quasi-periodic wave structure in a plan view and FIG. 14B in a sectional view, as it is exhibited by a patterned substrate which can be produced by a method disclosed herein, in particular by a multiple irradiation or by a single irradiation with high intensity. The sectional view of FIG. 14B represents a cross-section through the structure shown in FIG. 14A approximately along the sectional line A-A. Self-organization processes occurring in the materials lead to the formation of wave-shaped structures with wave crests 10 and wave troughs 11 within an area irradiated in this way. The resulting structures generally exhibit a certain periodicity, although defects 12, i.e. irregularities, also occur. Thus, in contrast to a truly periodic structure, such a structure exhibits both deviations in the structure dimensions, in particular in the distances between the wave crests and troughs, and defects, so that the generated wave structure is not homogeneous.

A visualization of the water contact angle 13 is shown in FIG. 15. A liquid 14 is arranged here in droplet form on a substrate 5. Outside the drop of liquid, air is present in the gaseous phase. The water contact angle 13 is the angle between the surface of the substrate 5 and the tangent 16 adjacent to the drop of liquid. The tangent 16 is considered to be in contact with the surface of the substrate 5.

1-31. (canceled)

32. A patterned substrate (5) comprising a surface with anti-fogging properties, the surface comprising a patterned region (28) and an unpatterned region (29)
wherein the patterned region (28)
a) is formed by a first periodic dot structure in the micro- or sub-micrometer range with a first interference period (p1) in the range of 50 nm to 50 μm;
or
b) by a first periodic dot structure in the micro- and/or sub-micrometer range with a first interference period (p₁) in the range from 50 nm to 2.0 μm or in the range from 9.5 μm to 50 μm,
wherein the first periodic dot structure is formed of inverse cones (14) or cones, the inverse cones are formed into the substrate to be patterned, the inverse cones having a rounded cone tip at their saddle point,
wherein the surface of the substrate having the first dot structure has a water contact angle (23) of less than 20°, preferably less than 10°, preferably less than 5° when wetted with water.

33. The patterned substrate (5) according to claim 32, wherein the patterned substrate (5) comprises a material whose unpatterned surface has hydrophilic properties, wherein the first periodic dot structure is arranged on and/or in this material.

34. The patterned substrate (5) according to claim 32, wherein the patterned substrate (5) is transparent.

35. The patterned substrate (5) according to claim 32, wherein the first periodic dot structure has a structure depth in the range of 0.05 μm and 2 μm.

36. The patterned substrate (5) according to claim 32, wherein the substrate (5) has a transmittance of at least 50% or preferably at least 70% or particularly preferably at least 80% or at least 90% for each wavelength in the partial range in a partial range of the electromagnetic spectrum.

37. The patterned substrate (5) according to claim 32, wherein the partial range comprises electromagnetic radiation in the range from 380 nm to 780 nm,
wherein the transmission in said partial range is at least 50% for each wavelength in said partial range.

38. The patterned substrate (5) according to claim 32, wherein a further periodic structure is superimposed on the periodic dot structure.

39. The patterned substrate (5) according to claim 32, wherein the surface of the substrate comprising the first dot structure has hydrophilic and/or super-hydrophilic properties.

40. The patterned substrate (5) according to claim 32, wherein the water contact angle (23) over the surface comprising the first periodic dot structure varies only by a maximum of 5°, preferably a maximum of 3°.

41. The patterned substrate (5) according to claim 32, wherein a line structure with dimensions in the micro- and/or sub-micrometer range is superimposed on the first periodic dot structure with dimensions in the micro- and/or sub-micrometer range.

42. The patterned substrate (5) according to claim 32, wherein the line structure is in the form of a wave structure and has quasi-periodic properties and wherein the interference period of the wave structure is in the range of 100 nm to 500 nm.

43. The patterned substrate (5) according to claim 32, wherein the spatial position of the quasi-periodic wave structure (19) is coupled to the position of the inverse cones (14) or cones forming the periodic dot structure, wherein the quasi-periodic wave structure (19) is located within or on the surface of the inverse cones, on the surface of the inverse cones (14) or cones and the region (28) between the inverse cones (14) or cones of the substrate (5), which is unpatterned by the periodic dot structure, remains unpatterned.

44. The patterned substrate (5) according to claim 32, wherein the line structure superimposed on the first periodic dot structure is periodic, wherein the periodic line structure patterns the substrate (5) uniformly within an interference pixel, and the line structure comprises an interference period which has dimensions in the range of 1% to 30% of the interference period of the first periodic dot structure.

45. The patterned substrate (5) according to claim 32, wherein a further periodic dot structure with dimensions in the micro- and/or sub-micrometer range is superimposed on the first periodic dot structure with dimensions in the micro- and/or sub-micrometer range, wherein the further periodic dot structure patterns the substrate (5) uniformly within an interference pixel and the further dot structure has an interference period which has dimensions in the range of 1% to 30% of the interference period of the first periodic dot structure.

46. The patterned substrate (5) according to claim 32, wherein the surface of the substrate comprising the first dot structure has self-cleaning properties.

47. The patterned substrate (5) according to claim 32, comprising a coating, wherein the coating is arranged on the substrate on the patterned surface such that the first dot structure is formed in the coating and in an underlying layer.

48. A method for producing a substrate (5) with a periodic dot structure in the micro- and/or sub-micrometer range which has anti-fogging properties according to claim 32 by means of direct laser interference patterning, comprising the following steps:
a) Providing a substrate,
b) Applying a first periodic dot structure having a first interference period,
wherein the periodic dot structure is formed by superimposing partial laser beams divided from a laser beam by means of a beam splitter element (2) in an interference region, also interference pixels,
wherein the first periodic dot structure is formed of inverse cones (14), the inverse cones being formed in the substrate to be patterned,
characterized in that A) the interference period of the periodic dot structure is in the range of 50 nm to 50 μm and the periodic dot structure with the first interference period is generated within an interference pixel by means of single irradiation by a laser pulse,
or
B) the interference period of the periodic dot structure is in the range from 50 nm to 2.0 μm and/or in the range from 9.5 μm to 50 μm and the periodic dot structure with the first interference period is generated within an interference pixel by means of a plurality of successive laser pulses by multiple irradiation or by single irradiation by a laser pulse.

49. The method according to claim 48, wherein a multiple irradiation with identical process parameters of an interference pixel takes place, so that a quasi-periodic line structure superimposed on the first periodic dot structure is formed as a wave structure by self-organization processes.

50. The method according to claim 48, wherein a further periodic dot structure mor periodic line structure with an interference period identical to the first interference period or with an interference period different from the interference period of the first periodic dot structure is applied to the substrate (5) by multiple irradiation with deviating process parameters.

51. The method according to claim 48, wherein the method additionally comprises the following steps:
c) Providing a further substrate (5), wherein the further substrate is preferably transparent
d) embossing the first substrate onto the further substrate (5) so that a periodic dot structure comprising cones is formed thereon.
